(19) United States
(12) Patent Application Publication
(10) Pub. No.: US 2021/0119956 A1
(43) Pub. Date: Apr. 22, 2021

(54) Integrating a Search Service with a Social Network Resource

(71) Applicant: MICROSOFT TECHNOLOGY LICENSING, LLC, Redmond, WA (US)

(72) Inventors: Meredith J. Morris, Bellevue, WA (US); Jaime Teevan, Bellevue, WA (US); Katrina M. Panovich, Cambridge, MA (US); Aravind Bala, Redmond, WA (US); Jonathan Garcia, Duvall, WA (US); Susan T. Dumais, Kirkland, WA (US); Eric J. Horvitz, Kirkland, WA (US)

(21) Appl. No.: 17/133,422

(22) Filed: Dec. 23, 2020

Related U.S. Application Data
(63) Continuation of application No. 12/756,202, filed on Apr. 8, 2010, now abandoned.

(51) Int. Cl. H04L 12/58; H04L 12/18

(52) U.S. Cl. CPC H04L 51/32; H04L 12/185

(57) ABSTRACT

A system is described for integrating a search engine and one or more social network resources. The system operates by determining whether a search operation being conducted by a user warrants interaction with a social network resource. If so, the system may provide an invitation to the user to forward a query-related message to the social network resource. The system then sends the message to a group of contacts via the social network resource, where the group of contacts can be defined in various ways. The system receives a response from at least one contact in the group of contacts and presents that response to the user using various delivery mechanisms, as governed by various delivery timings.

### RELATED APPLICATION

This application is a continuation of U.S. patent application Ser. No. 12/756,202 filed Apr. 8, 2010, the contents of which are incorporated herein by reference in their entirety.

### BACKGROUND

A user commonly retrieves information from a network-accessible resource (such as the Internet) using a search engine. In this approach, the user submits a search query that includes one or more key terms. The search engine responds by identifying and forwarding results that match the search query.

A user can also obtain information by interacting with one or more human contacts over a network (such as the Internet) using a social network resource. Some types of social network resources adopt a traditional conversational paradigm for asking and answering questions. For example, a user may use an Email service, an instant messenger (IM) service, a voice-over-IP (VOIP) service, etc. to pose a question to a group of contacts. Some services facilitate such exchange by providing customized functionality for directing questions to appropriate individuals. These types of services are also known as expert-finding services.

Other social network resources serve the primary role of disseminating information to users. Well known examples of such services include Facebook, Inc. of Palo Alto, Calif., MySpace of Beverly Hills, Calif., and LinkedIn of Mountain View, Calif. In practice, a user may create a profile using such a service and establish links to other users who also maintain profiles on the service. Yet another way to disseminate information to groups of contacts is Twitter of San Francisco, Calif. In this service, a user can send short messages (“posts”) to recipients (“subscribers” or “followers”) who wish to receive these messages. As stated, these types of social network resources are predominantly used to distribute information; but users sometimes use these services to pose questions. For example, a user can pose a question in the form of a status message that appears on his or her profile page.

Search engines and social network resources have respective strengths and weaknesses as tools for answering a user's questions. For example, a search engine typically has access to a greater wealth of information compared to a social network resource. Further, a search engine can typically deliver information in a more private, predictable, and expedited manner compared to a social network resource. In contrast, a social network resource typically accommodates a more free-form and natural manner of asking questions compared to a search engine. Further, a social network resource can facilitate disambiguation of queries, since a human recipient may, in some instances, more readily understand the identity, deeper goals, and informational needs of a user posing a query; further, a human recipient may more readily understand a background context associated with the query compared to a search engine. Further, a social network resource may provide information that is potentially more trustworthy compared to a search engine (because it may originate from trusted individuals or from people with a reputation for providing valuable and accurate answers). Further, a social network resource can sometimes provide information that is less patterned, focused, and regularized, and thus more unexpected compared to a search engine; a social network resource may therefore better direct the user to serendipitous topics of interest compared to a search engine.

Some efforts have been made to combine features of search services and social network services. For example, one search engine has been proposed which identifies a user's contacts within the context of a search operation. Yet there remains room for considerable improvement in such hybrid type of systems.

### SUMMARY

A system is described for integrating a search service with a social network resource. According to one illustrative implementation, the system determines whether a search operation engaged in by a user warrants interaction with the social network resource. If so, the system provides an invitation to the user to forward a message to the social network resource. The message presents a question, related to the search operation, to a group of contacts affiliated with the social network resource (where the contacts can be defined in various ways). The system can also interact with the user to generate the message. The system then sends the message to the group of contacts via the social network resource.

According to another illustrative feature, the system can also receive a response by from at least one contact in the group of contacts. The system can present the response to the user using various delivery mechanisms, as governed by various delivery timings. For example, in one scenario, the system can present the response in the context of the same search engine result page (SERP) through which the user is conducting the search operation.

According to another illustrative feature, the system can determine whether the search operation warrants interaction with the social network resource by determining whether the search operation conforms to one or more predetermined scenarios. In one case, the system assesses whether the search operation pertains to a certain topics for which interaction with the social network resource is deemed warranted, appropriate, or valuable. In another case, the system assesses whether the search operation pertains to an extended search task, in which case interaction with the social network resource is deemed warranted. In another case, the system assesses whether the user has failed in retrieving satisfactory search results, in which case interaction with the social network resource is deemed warranted. In another case, the system can determine that the search operation warrants interaction because the user expressly requests such interaction. Still other factors and combinations of factors can be used to assess the appropriateness of sending a message to the social network resource.

According to another illustrative feature, the system can suggest a phrasing of the message to the user. In addition, or alternatively, the system can propose plural messages to the user, allowing the user to select a message that is deemed most appropriate. In addition, or alternatively, the system can receive an editing input from the user by which the user can manually specify the phrasing of the message. In addition, or alternatively, the system can allow the user to compose a message that has multiple components; one part may correspond to a textual message, another part may correspond to options that help guide a contact's response, and so on. The system can provide a structured interface that allows the user to compose such a multi-component message.

According to another illustrative feature, the system can use an integration module to perform various aspects of the functions described above. The integration module can interact with a search engine through which the user is conducting the search operation, as well as the social network resource. In one case, the integration module can compose the message by drawing message data pertaining to the search operation from one or more sources. One possible source is the search engine. Another possible source is a result storage module which temporarily stores the message data from the search operation. The integration module can pull the message data from the result storage module when the message data is volatile, meaning that there is some risk that it can change over time.

According to another illustrative feature, the system can also achieve integration in the “opposite direction,” e.g., by routing questions received via a social network resource to the search engine. An automated response agent can perform this function. In one case, the user can designate such an automated response agent as a “friend” on his or her social network resource.

According to another illustrative feature, the system can receive a response from a contact as per a delivery timing that is at least one of: (a) soon after the message is sent based on pre-stored information maintained by the social network resource (and/or elsewhere); (b) in a same search session in which the message is sent; (c) after the search session in which the message is sent, etc. In the first timing category (a), the system can provide information without waiting for a response from the human contacts; hence, the user may receive the response soon after he or she submits the message. This type of response (which is based on pre-stored information) can also be automatically supplied, e.g., without asking the user to expressly respond to an invitation; further, this type of response can also be supplied without any type of supplemental interaction with the human contacts.

According to another illustrative feature, a delivery mechanism that is used to present the response can include any of: (a) a search result page which mixes search results from the search engine with responses from the social network resource; (b) a search result page that is dedicated to the presentation of responses from the social network resource; (c) a mechanism outside a context of the search engine, etc.

According to another illustrative feature, the system can provide an analysis module that analyzes responses received from contacts. The analysis module can classify the responses into various topics, e.g., into a hierarchy of such topics. The system can use the results of such analysis to improve its performance in various ways.

According to another illustrative feature, the system can allow users to evaluate the responses received from contacts. The feedback provided by users can be used to improve the performance of the system in various ways.

According to another illustrative feature, the system can forward messages to message-feeder agents that are associated with respective topics. Contacts who subscribe to these message-feeder agents can view the messages presented by the agents and respond to the messages. In this implementation, the system can effectively shield the identity of the user from the contacts, and vice versa.

According to another illustrative feature, the system can identify and store search information regarding prior search operations; for each such search operation, a social network resource is deemed to have been more successful in addressing a user's informational needs compared to the search engine. The system can use this information to build a model. That model, in turn, can be used to improve the performance of the search engine and/or other aspects of the system.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative system for integrating a search engine and one or more social network resources.

FIG. 2 shows an illustrative protocol that sets forth one manner of operation of the system of FIG. 1.

FIG. 3 elaborates on FIG. 2 by showing a protocol for a generating a message in the course of a search operation, and for forwarding the message to a social network resource.

FIG. 4 shows an illustrative message preparation module for generating and forwarding a message.

FIG. 5 shows functionality for presenting a message to a group of contacts, receiving at least one response from the contacts, and presenting the response to the user conducting the search operation.

FIG. 6 shows functionality for disseminating messages to contacts via one or more message-feeder agents, and for analyzing and evaluating responses received from the contacts.

FIG. 7 shows functionality for subscribing to message-feeder agents and for interacting with those message-feeder agents.

FIG. 8 shows illustrative functionality for implementing various individual modules shown in FIGS. 4-7.

FIG. 9 shows an illustrative search presentation that includes invitations that prompt a user to interact with a social network resource.

FIG. 10 shows an illustrative interface that is invoked when the user activates one of the invitations; the interface allows a user to generate a message to be forwarded to the social network resource.

FIG. 11 enumerates various options for collecting responses and presenting those responses to a user.

FIG. 12 shows various ways for presenting a response to a user in the context of a search engine result page, for various respective delivery timings.

FIG. 13 shows other illustrative delivery mechanisms for delivering responses to the user.

FIG. 14 shows another illustrative search presentation that includes an invitation that prompts a user to interact with a social network resource.

FIG. 15 shows illustrative interfaces that are invoked when the user activates the invitation in FIG. 14.

FIG. 16 shows an illustrative procedure for generating and sending a message to a social network resource.

FIG. 17 shows an illustrative procedure for receiving and responding to the message generated as per the procedure of FIG. 16.

FIG. 18 shows an illustrative procedure for presenting one or more responses that are provided as per the procedure of FIG. 17.

FIG. 19 shows an illustrative procedure for integrating a search engine and a social network resource in an “opposite direction,” e.g., in which questions originate from the social network resource.

FIG. 20 shows an illustrative procedure for providing messages to contacts via one or more message-feeder agents.

FIG. 21 shows an illustrative procedure for subscribing to a message-feeder agent, and for allowing a user to interact with this message-feeder agent.

FIG. 22 shows an illustrative procedure for receiving responses from contacts and for analyzing and archiving the responses, and for optionally collecting and storing feedback from recipient users.

FIG. 23 shows an illustrative procedure for building a model and using the model to improve aspects of the search engine.

FIG. 24 shows illustrative computing functionality that can be used to implement any aspect of the features shown in the foregoing drawings.

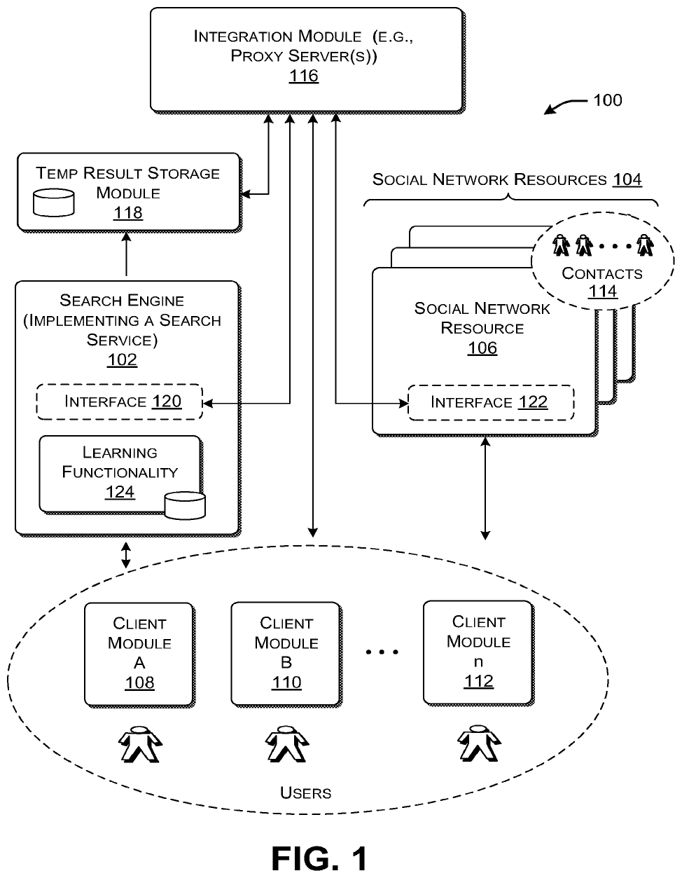

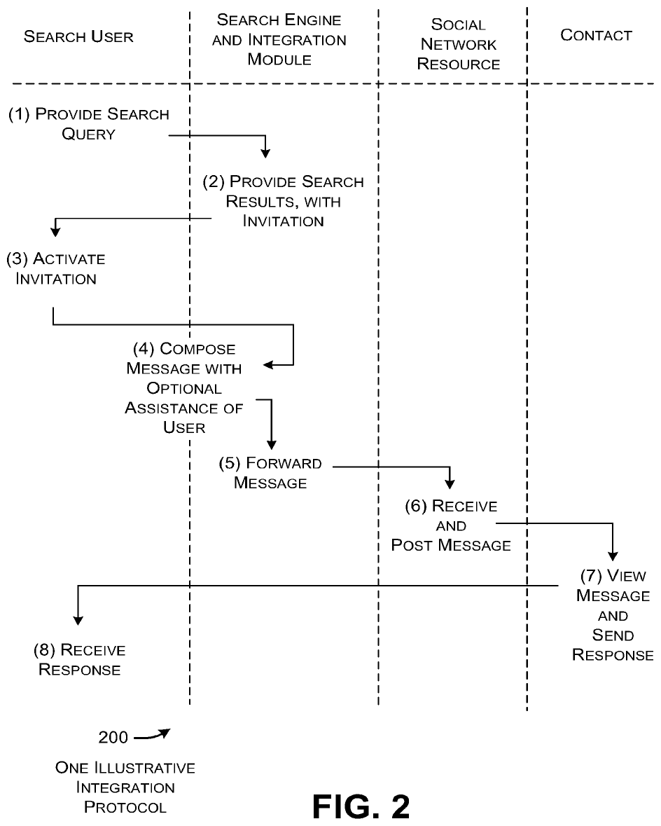

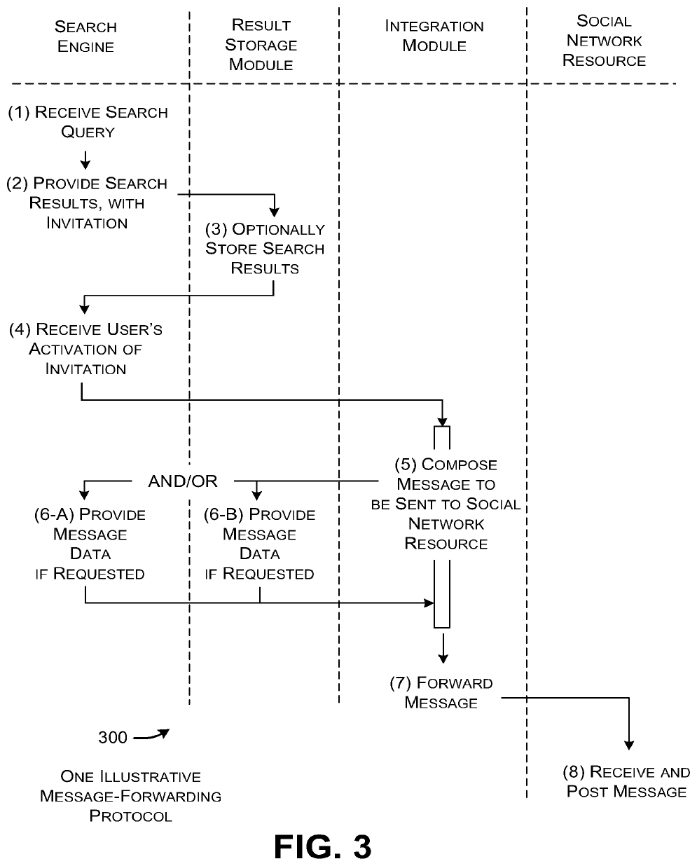

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

The disclosure is organized as follows. Section A describes an illustrative system which integrates a search engine and one or more social network resources. Section B describes illustrative methods which explain the operation of the system of Section A. Section C describes illustrative processing functionality that can be used to implement any aspect of the features described in Sections A and B.

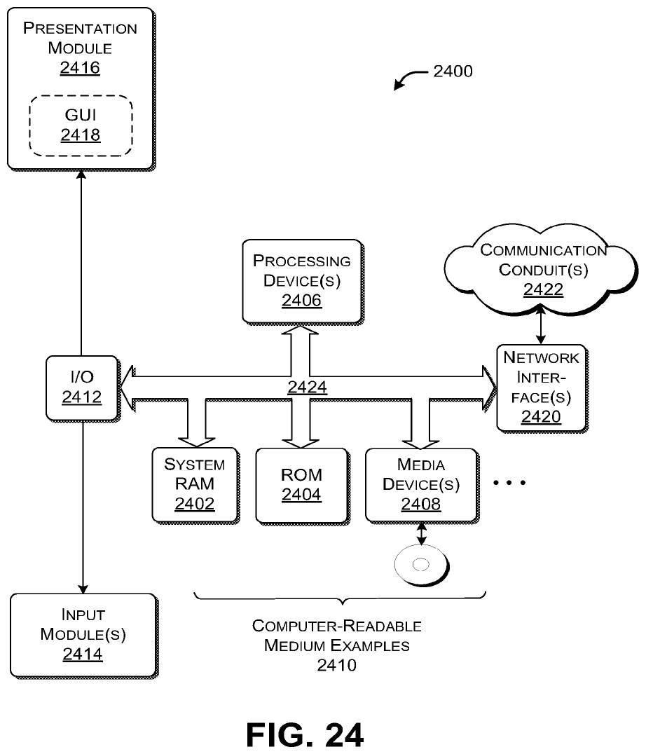

As a preliminary matter, some of the figures describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 24, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

As to terminology, the phrase “configured to” encompasses any way that any kind of functionality can be constructed to perform an identified operation. The terms “logic” or “logic component” encompass any functionality for performing a task. For instance, each operation illustrated in the flowcharts corresponds to a logic component for performing that operation. When implemented by a computing system, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Systems

A.1. Overview of Illustrative Architecture

FIG. 1 shows a system 100 which integrates at least one search engine 102 and one or more social network resources 104. To facilitate discussion, the social network resources 104 will be described mainly in the context of a representative social network resource 106.

The search engine 102 and the social network resource 106 may be implemented in any manner. For example, each of the search engine 102 and the social network resource 106 can be implemented by one or more computers (e.g., a server farm or the like) in conjunction with one or more data stores and other data processing equipment. Each of the search engine 102 and the social network resource 106 can be implemented by equipment disposed at a single site or, in distributed fashion, equipment disposed over multiple sites.

Users may interact with the search engine 102 and the social network resource 106 using respective client modules, e.g., client module A 108, client module B 110, client module n 112, etc. The client modules (108, 110, . . . 112) can be implemented in any manner. For example, any of the client modules (108, 110, . . . 112) can be implemented as a desktop computing device, a laptop computing device, a personal digital assistant (PDA) type computing device, a stylus-type computing device, a mobile phone type computing device, a game console device, a set-top box device, and so on. The client modules (108, 110, . . . 112) may be coupled to the search engine 102 and social network resource 106 via one or more networks (not shown), referred to in the singular below (as a “network”) for brevity. The network can be implemented by any combination of hardwired links, wireless links, router devices, name server devices, gateways, etc., as governed by any protocol or combination of protocols.

The search engine 102 implements any type of search service. One example of a commercial search engine is the Bing™ search engine provided by Microsoft Corporation of Redmond, Wash. In operation, a user (or user agent) may submit a search query to the search engine 102 that is composed of one or more search terms. In response, the search engine 102 searches a repository of items to identify one or more items which match the search query (if there is, in fact, at least one item that matches the search query). In one case, the search engine 102 searches a discrete data store or plural discrete data stores for matching items. Alternatively, or in addition, the search engine 102 searches a collection of repositories maintained by a wide area network (WAN) or the like, such as the Internet. The search engine 102 returns results which identify the matching items to the user (or user agent). That is, the results may comprise a list of links that the user may activate to further explore the matching items.

The social network resources 104 can encompass any service that allows users to interact with respective groups of contacts. One or more of the social network resources 104 may provide functionality that facilitates a conversational mode of interaction. This type of social network resource encompasses an Email service, an instant messenger (IM) service, a voice-over-IP (VOIP) service, a message board service, and so on. One or more other social network resources 104 may provide functionality that allows users to maintain personal profiles and/or to establish links which identify their respective contacts. This type of social network resource encompasses services such as Facebook, Inc. of Palo Alto, Calif., MySpace of Beverly Hills, Calif., and LinkedIn of Mountain View, Calif., and so on. One or more other social network resources 104 may provide functionality which allows users to broadcast messages to subscribing contacts. This type of social network resource encompasses services such as Twitter of San Francisco, Calif. Another type of social network resource is any type of question-answer (QA) resource that includes functionality for facilitating the asking and answering of questions. The above explanation provides a representative and non-exhaustive list of possible social network resources; other implementations can incorporate other types of social network resources or omit one or more of the social network resources mentioned above. In general, the search engine 102 and the social network resource 106 can be administered by different respective entities or the same entity.

In one case, for each social network resource, the users may expressly select their contacts, e.g., by manually identifying their friends, family members, work colleagues, club members, etc. In addition, or alternatively, the system 100 can dynamically create a contact group for a user. For example, assume that the system 100 detects that the user is asking a question from a particular geographical region, which can be assessed based on the IP address of the user's computer (or the like) or based on the user's profile information maintained by a social network resource or based on some other source. Or assume that the user is asking a question that concerns a particular geographical region, which can be determined by extracting geographical information from the query and/or from the search results. In either case, the system 100 can cull a subset of individuals who are associated with the defined geographical area and treat that subset as a group of contacts. In this circumstance, there may be no pre-established relationship between users and contacts. Still other factors and combination of factors can be used to identify a dynamic group. For example, the system 100 can define a group that is composed of individuals to whom the user has sent Email messages within a recent time span, e.g., the last day or the last week, etc.

Alternatively, or in addition, the system 100 can allow contacts to subscribe to various topics. The system 100 can then assess the topics of messages and forward the messages to subscriber-contacts on a topic-related basis. Again, in this circumstance, there may be no pre-established relationship between the users and the contacts. Subsection A.4 (below) provides additional details regarding this mode of operation.

In general, FIG. 1 shows an illustrative group of contacts 114 who interact with the social network resource 106. These contacts 114 may be defined in any manner described above.

The system 100 can implement sharing between the search engine 102 and the social network resources 104 in various ways. FIG. 1 shows one illustrative approach. Here, an integration module 116 interacts with both the search engine 102 and the social network resources 104. That is, the system 100 can call the integration module 116 when a user, who is performing a search operation, invokes a command to share a message with a social network resource—for example, the social network resource 106. The integration module 116 then prepares the message to be sent to the social network resource 106. This preparation may involve interaction with the user. Further, this interaction may involve retrieving message data directly from the search engine 102 or from a result storage module 118 (to be discussed below).

FIG. 2 shows one illustrative protocol 200 which sets forth one manner of operation of the system 100 of FIG. 1. In operation (1), a user provides a search query to the search engine 102. In operation (2), the search engine 102 provides search results to the user. In certain cases, the system 100 determines that the user's search operation warrants interaction with a social network resource. If so, the search engine 102 also provides at least one invitation to the user to interact with the social network resource. In operation (3), the user may activate the invitation, e.g., by clicking on the invitation. In operation (4), the integration module 116, in potential cooperation with the search engine 102, result storage module 118, and/or the user, composes a message. In operation (5), the integration module 116 forwards the message to the social network resource. In operation (6), the social network resource receives and posts the message. In operation (7), at least one contact reviews the message that is posted to the social network resource and sends a response to the message. In operation (8), the user receives the contact's response.

As will be discussed in greater depth below, the protocol 200 of FIG. 2 can be varied in different ways. For example, the system 100 can perform various operations without interacting with the user. For example, the system 100 can send a message to the social network resource without sending an invitation to the user and/or without soliciting the user's assistance in composing the message. In one case, each user can control the interactive behavior of the system by specifying preference information.

FIG. 3 shows a protocol 300 that provides additional details regarding the manner of operation outlined in FIG. 2. For example, FIG. 3 presents additional details regarding one way in which the system 100 compose a message for forwarding to the social network resource (e.g., corresponding to operation (4) in FIG. 2). In operation (1), the search engine 102 receives a search query from the user. In operation (2), the search engine 102 provides search results that may include one or more invitations to interact with the social network resource. In operation (3), the result storage module 118 stores message data that pertains to the search results (for reasons explained below). In operation (4), the search engine 102 receives the user's activation of an invitation. In operation (5), the integration module 116 composes the message to be sent to the social network resource. As indicated in operation (6-A), the integration module 116 can retrieve message data directly from the search engine 102 in the course of preparing a message. For example, the integration module 116 can invoke a background search using the search engine 102 to retrieve message data that will be inserted into the message (in a manner to be clarified below). Alternatively, or in addition, as indicated in operation (6-B), the integration module 116 can retrieve previously stored message data from the result storage module 118. Once the message is composed, in operation (7), the integration module 116 forwards the message to the social network resource. In operation (8), the social network resource receives the message.

The system 100 may temporarily store message data in the result storage module 118 to address the possibility that a follow-up search will not retrieve the same results as an initial search. For example, assume that a user performs a search to retrieve vacancy information for hotels in particular city. The user then invokes an invitation to share a message related to the query. The user will want the message that is composed and sent to the social network resource to include the same message data that is displayed to the user upon performing an initial search. If there is a risk that this data may change, the integration module 116 can retrieve the message data from the result storage module 118, rather than performing a follow-up background search using the search engine 102. The result storage module 118 can be configured to delete message data for searches after a prescribed period of time, such as, without limitation, 24 hours after the storage of this message data. Such message data may or may not be used to compose a message for sharing within this period of retention.

Returning to FIG. 1, the integration module 116 can be implemented in any manner, such as by one or more proxy server computers in conjunction with one or more data stores and other data processing equipment. The result storage module 118 can be implemented in a similar manner, e.g., by one or more server computers and one or more data stores. The integration module 116 can interact with the search engine 102 via an interface 120; the integration module 116 can interact with the representative social network resource 106 via an interface 122. In one case, the interfaces (120, 122) may correspond to application programming interfaces (APIs) or the like. In one illustrative and non-limiting case, these interfaces (120, 122) may accept requests and provide response data in a markup language format, e.g., the extensible markup language (XML), etc. Physically, the integration module 116 can interact with any module in the system 100 (e.g., the search engine 102, the social network resource 106, the result storage module 118, the users, etc.) via any type of network, such as a local area network, wide area network, etc., or any combination thereof.

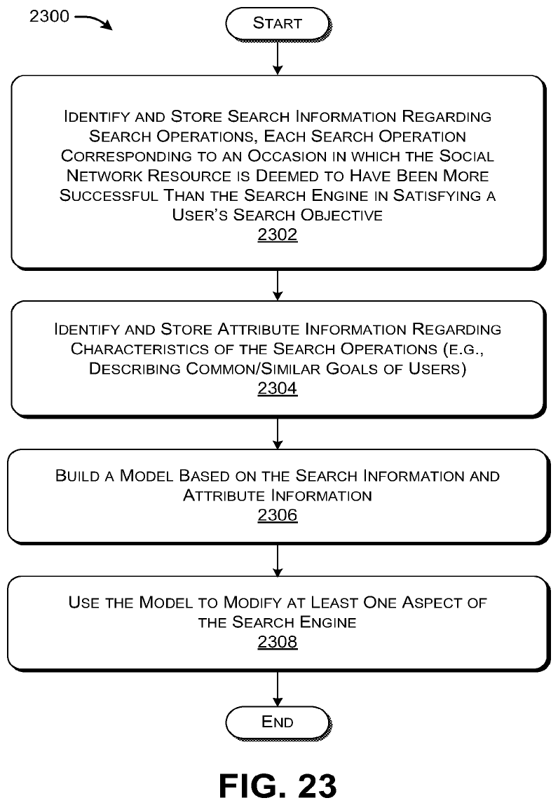

The system 100 can also include learning functionality 124. FIG. 1 illustrates the learning functionality 124 as being implemented by the search engine 102. But this functionality can alternatively, or in addition, be implemented by other agents within the system 100, including a separate learning agent. The purpose of the learning functionality 124 will be described in Section B (with respect to FIG. 23). Generally stated, the learning functionality 124 can identify those search operations for which a social network resource is deemed to have been more successful in addressing the users' informational needs compared to the search engine 102; the learning functionality 124 can use this information to help improve the services offered by the search engine 102 and/or other aspects of the system 100.

The system architecture illustrated in FIG. 1 shows one implementation among many possible implementations. In other cases, one or more functions performed by the integration module 116 can be, instead, or in addition, performed by the search engine 102. Also, one or more functions performed by the integration module 116 can be, instead, or in addition, performed by the social network resources 104. Indeed, in one case, the integration module 116 can be eliminated in its entirety. For these reasons, the remaining sections will describe the operation of the system 100 in terms of functional modules; these functional modules can be implemented by any components, or combinations of components, shown in FIG. 1.

Likewise, the protocols (200, 300) shown in FIGS. 2 and 3 can be varied in any number of ways. For example, in one variation, when a user clicks on an invitation in the search results, the system 100 directly invokes an appropriate social network resource. The social network resource may then call on the integration module 116. The integration module 116 then composes the messages in the manner described above. Many other variations in the protocol are possible.

A.2. Functionality for Preparing a Message

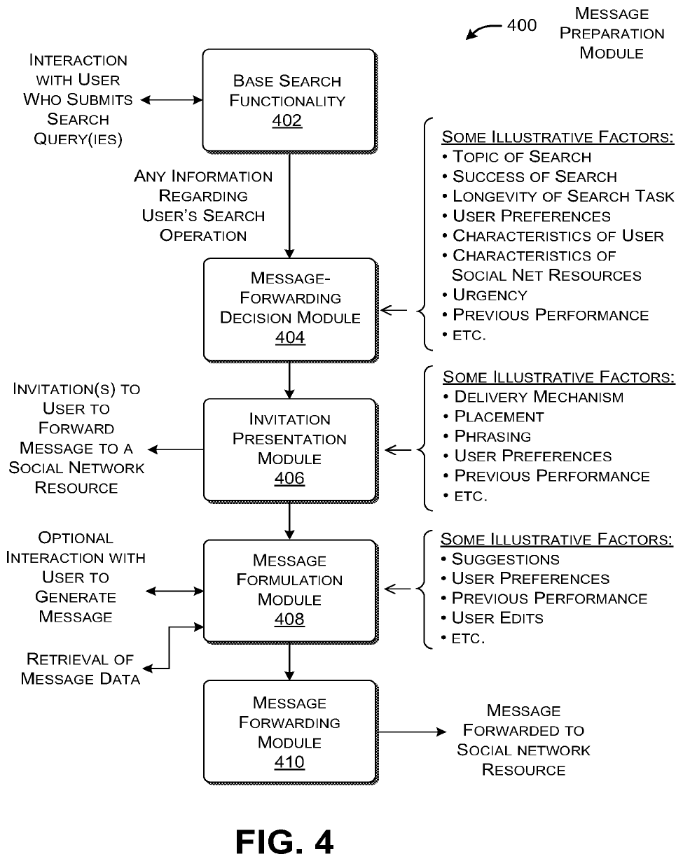

FIG. 4 shows a message preparation module 400 that is used to generate and send a message to a group of contacts in the course of performing a search operation. The message preparation module 400 can be implemented by the system 100 in different ways. In one case, different aspects of the message preparation module 400 can be implemented by the search engine 102 and the integration module 116 (in a manner described below). The message preparation module 400 includes, or can be conceptualized to include, a collection of component modules, described in turn below from top to bottom.

The message preparation module 400 includes base search functionality 402 for performing search operations. The search operations include accepting a search query from a user that may be composed of one or more search terms and/or a natural language expression. The base search functionality 402 determines whether one or more items match the search query, e.g., by searching an index of the items in a conventional manner. The base search functionality 402 returns a list of any items that match the search query.

A message forwarding decision module 404 (referred to below as the “decision module” for brevity) determines whether the search operation that the user is presently engaged in warrants interaction with a social network resource. That is, not every search query is a good candidate to share with the user's contacts. For example, the user may be submitting a very quick and predictable query that the search engine 102 is expected to satisfy without complication. This means that it may not be fruitful to interact with the user's contacts for this type of search query. This decision helps reduce the amount of “spam-like” content that is presented to the user's contacts (and it also reduces the amount of non-meaningful responses that may return to the user as a result the question that is posed). Or the user may be submitting a query of a personal nature (e.g., regarding a health issue). Here, the user may not wish to share the query to maintain the confidence of the personal information.

The decision module 404 can gauge whether it is appropriate to interact with a social network resource using various factors and/or various combinations of different factors. The following explanation provides a representative and non-exhaustive list of possible factors.

In one case, the decision module 404 can determine whether a search operation that the user is conducting corresponds to one or more topics for which interaction is deemed appropriate. In one case, the decision module 404 can make this decision by comparing terms in the user's current search query with a user-created mapping of key terms to triggering topics. In another case, the decision module 404 can consult a third-party mapping of key terms to topics. One such third-party mapping is provided by the open directory project (ODP). In another case, the decision module 404 can analyze the search operation to determine whether it relates to one or more topics for which different respective message-feeder agents exist (to be described below in Subsection A.4). In another case, the decision module 404 can consult a classifier engine of any type (such as a machine learning model) to map a search query to an assessed topic, or, more directly, to map a search query to a decision as to whether to forward a message to the social network resource. In general, examples of topics that may warrant interaction include, but are not limited to: restaurants; movies; music; sports; local services; local businesses; local events; travel; technical support; shopping and product reviews; news, etc.

Alternatively, or in addition, the base search functionality 402 may classify the search query into an instant answer category, such as movies, news, sports, etc. The base search functionality 402 may provide quick answers for these types of queries and present these answers in a prominent part of the search engine result page (SERP) in a defined format. The decision module 404 can identify one or more of these instant answer categories as appropriate topics for interaction with a social network resource. Thus, if the base search functionality 402 classifies the search query into an instant answer category of this type, the decision module 404 indicates that this search query also warrants interaction with the social network resource.

Alternatively, or in addition, the decision module 404 can assess the topic of the search operation by examining the content of the search results returned by the search engine 102. Again, based on the assessed topic, the decision module 404 determines whether the search operation warrants interaction with the social network resource. The decision module 404 can perform this analysis based on mapping information established by a user, mapping information provided by a third-party entity, a model of any type, etc.

Alternatively, or in addition, the decision module 404 can assess the topic of the search operation by examining one or more previous (non-current) search queries and/or one or more previous (non-current) search results. This approach may be effective in those cases in which the user is conducting an extended search task (to be discussed below in greater detail). The decision module 404 can even mine information regarding the topic from previous messages sent by the user to his or her contacts, and the responses received from the contacts.

Alternatively, or in addition, the decision module 404 can determine whether the user is having success in finding desired information. If not, the decision module 404 can conclude that it may be appropriate to interact with a social network resource, e.g., to thereby receive the help of the user's contacts in finding the desired information. The decision module 404 can apply any criterion or criteria in assessing the success of a search operation. In one case, the decision module 404 can determine that a search is unsuccessful when the search operation returns no results or returns a number of results below a defined threshold. Alternatively, or in addition, the decision module 404 can determine that a search is unsuccessful when it is detected that the user has refined the search query several times within a short period of time but has not clicked on any results. Alternatively, or in addition, the decision module 404 can use an automated engine to determine whether the user is about to switch from one search engine to another. Such an automated engine can apply a model which maps various input features to an output conclusion (regarding whether the user is about to switch engines); such input features can pertain to any of: the search query; the search results (and the behavior of the user with respect to the results); the overall search session in which the user has submitted the query; the general search-related behavior of the user, and so on. Such a model can be trained with respect to the same input features.

Alternatively, or in addition, the decision module 404 can assess the longevity associated with a search operation. If the decision module 404 determines that a user's search query is part of an extended search task, then the decision module 404 can conclude that the user's search operation potentially warrants interaction with a social network resource. The decision module 404 can generally conclude that the user is engaged in an extended search task if the user submits a series of related search queries, and/or the user views a series of related pages identified in the search results. This may happen, for example, when a user plans a vacation; here, the user may research several related topics associated with a single destination, e.g., pertaining to restaurants, hotels, activities, flights, etc. at that destination. More specifically, in one implementation, the decision module 404 can conclude that the user is engaged in an extended search task using heuristics, such as by detecting that the user has refined a search query several times within a set time period, wherein the search queries issued within the set time period contain overlapping keywords and/or the search results returned by those queries contain overlapping sets of items.

Alternatively, or in addition, the decision module 404 can determine whether interaction with the social network resource is warranted based on explicit or implicit user settings. For example, a user can enter preference information which indicates that he or she does not want to share any messages with any social network resources. Or the user may indicate that he she wishes to share messages with social network resources in prescribed circumstances. The prescribed circumstances can be specified using any criteria and in any level of granularity. For instance, the user can specify criteria such as: the topics for which interaction is permitted; the times at which interaction is permitted; the social network resources (and/or individual contacts) with which interaction is permitted, and so on.

Alternatively, or in addition, the decision module 404 can determine whether interaction is appropriate based on various characteristics of a user and/or the contacts. For example, the decision module 404 can determine that the question-posing feature described herein is particularly popular for certain age groups, such as teenagers (in one hypothetical example). If the user's age matches one of those age groups, the decision module 404 will be more likely to invite the user to interact with a social network resource. The decision module 404 can obtain information regarding the user (or and/or any of the contacts) from various sources, such as profile information maintained by the social network resources 104, etc. For example, the decision module 404 can examine the interests of the user and/or the contacts in making a decision as to whether interaction is appropriate. For example, suppose that there is evidence that the user and/or the contacts are interested in conversing about restaurants, but not so much about movies. This conclusion can be based on the characteristics of these individuals and/or their behaviors (to be described below). In this circumstance, the decision module 404 will be more likely to initiate interaction for a search that is directed to a restaurant theme, compared to a search that is directed to a movie theme.

Alternatively, or in addition, the decision module 404 can determine whether interaction is warranted based on characteristics of the social network resources with which the user is associated. For example, a first user may have a particularly rich involvement with one or more social network resources, while a second user may rarely engage any social network resource. In addition, or alternatively, the first user may have many social contacts, while the second user may have a relatively small number of contacts. In either of these circumstances, the decision module 404 will be more likely to invoke the question-posing functionality for the first user compared to the second user.

Alternatively, or in addition, the decision module 404 can assess the urgency of a search operation in determining whether interaction with a social network resource is warranted. For example, the decision module 404 may decline to invoke the question-posing functionality if it determines that the user needs an immediate response to a question. Or the decision module 404 can selectively invite the user to interact with social network resources (such as an IM service) that have a higher probability of providing a quick response compared to others.

As part of seeking answers in urgent settings, the message preparation module 400 can invoke functionality that detects current presence and/or availability of the contacts and/or which provides a forecast pertaining to the future presence and/or availability of the contacts. The decision module 404 can then use such availability information in deciding whether it is appropriate to send a message (e.g., a query) to contacts. The message preparation module 400 can then use the availability information in deciding to whom the query is to be routed, e.g., by forwarding queries to contacts who are currently available and/or who are likely to remain available (and/or who are likely to become available).

The decision module 404 can also optionally include decision functionality which automatically assesses the urgency of a query, e.g., based on the nature of the query and/or other factor(s). The decision module 404 can use such a conclusion to determine whether it is appropriate to send a query to social contacts. This conclusion can also guide the message preparation module 400 in determining what contacts are appropriate to receive the query.

Alternatively, or in addition, the decision module 404 can assess the appropriateness of interacting with a social network resource based on either the prior behavior of the user or the prior behavior of the user's contacts, or both. For example, assume that the system 100 repeatedly invites the user to interact with social network resources (in previous search sessions), yet the user declines to utilize this feature. The decision module 404 may conclude that the user prefers not to use the question-posing functionality, upon which it will cease inviting the user to engage this functionality (or reduce the frequency at which it sends invitations). Or the decision module 404 can examine the utilization behavior of the user on a topic-by-topic basis and tailor its manner of operation accordingly. The decision module 404 can also examine the behavior of people who are assessed to be similar to the user and/or the user's contacts.

Alternatively, or in addition, the decision module 404 can determine that it is appropriate to interact with a social network resource because the user expressly makes such a request in the course of the search operation. This allows the user to invoke the message-sharing functionality independently of the automated analysis performed by the decision module 404 (as described above).

Again, the above list of factors is representative, rather than exhaustive. Further note that different decision factors may apply to different social network resources because different social network resources offer different respective benefits in different circumstances. This means that the decision module 404 may deem it appropriate to invite the user to interact with a first social network resource at a given time, but not a second social network resource.

Assume that the decision module 404 decides that it is appropriate to invite the user to interact with a social network resource. This conclusion can be made based on any factor described above or any combination of factors. At this juncture, the message preparation module 400 invokes an invitation presentation module 406. The invitation presentation module 406 sends one or more invitations to the user that invite the user to interact with one or more social network resources. Assume, to facilitate explanation, that the invitation presentation module 406 invites the user to interact with a single social network resource using a single invitation.

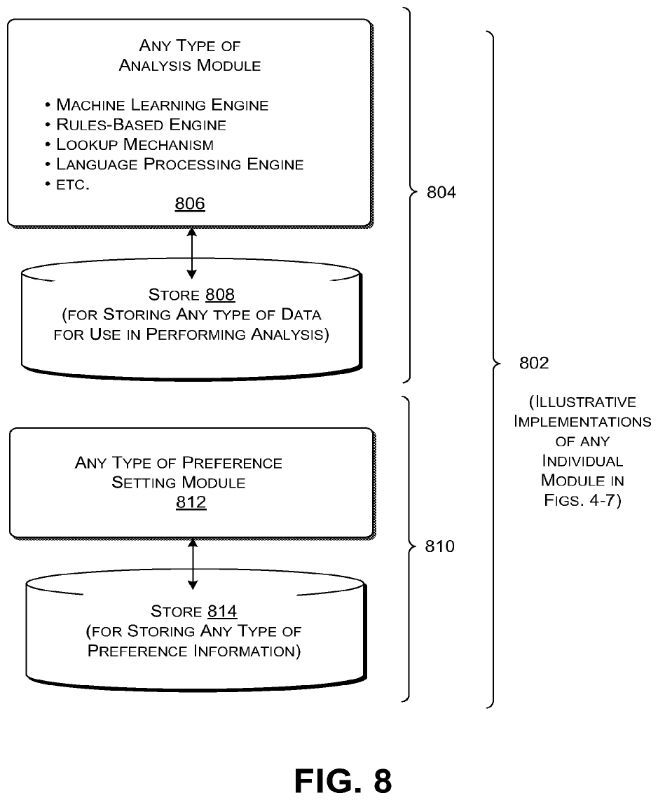

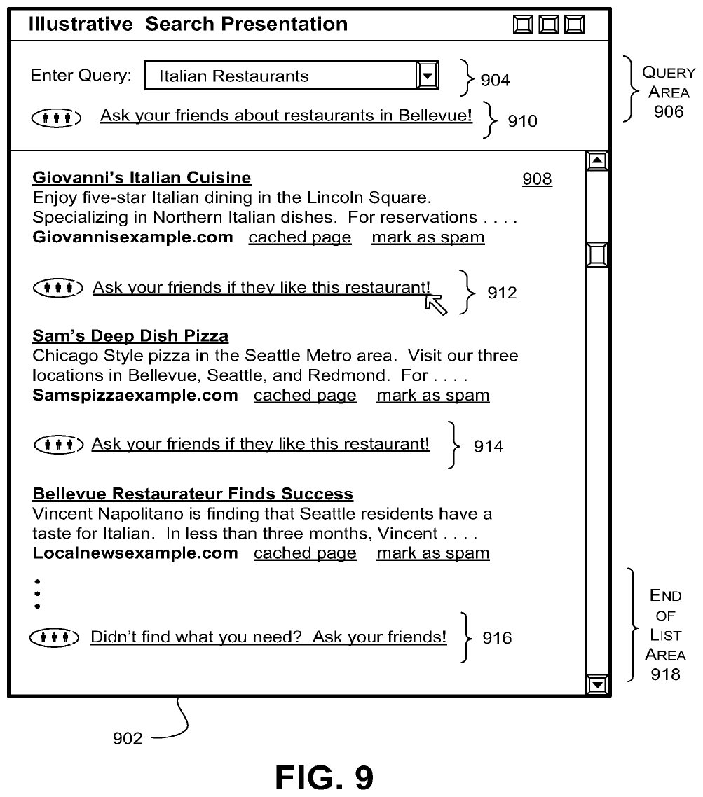

Various factors may have a bearing on the manner in which the invitation presentation module 406 operates. First, the invitation presentation module 406 decides what delivery mechanism is to be used to provide the invitation to the user. For example, the invitation presentation module 406 can decide to present the invitation to the user within the search engine result page (SERP) with which the user is presently interacting. In another case, or in addition, the invitation presentation module 406 can present the invitation to the user through a non-SERP channel, such as an IM service, an Email service, etc. Second, the invitation presentation module 406 can determine the manner in which it will present the invitation within the chosen delivery mechanism. Assume, for example, that the invitation is delivered via the SERP; in this case, the invitation presentation module 406 decides where to place the invitation within the SERP. Additional details regarding this feature will be described below when explaining FIG. 9.

The invitation presentation module 406 also determines the phrasing and formatting of the invitation. In a general case, the invitation presentation module 406 can present a generic message that reads, “Ask your friends about <query>,” where “<query>” refers to the text of the search query entered by the user. The invitation presentation module 406 can also select a phrasing which reflects the circumstances in which the invitation is invoked. For example, for a search operation that targets a specific movie, the invitation presentation module 406 can present the invitation which reads, “Invite your friends to see <movie name> with you,” or “Ask your friends what they thought of <movie name>.” The text enclosed in brackets reflects information that the invitation presentation module 406 fills in depending on the context in which the invitation is invoked. For a search operation that appears to target a general subject, the invitation presentation module 406 can present the invitation which reads, “Ask your friends if they can recommend a <query topic>,” or “Ask your friends what they think about <query topic>,” and so on. Again, FIG. 9 will be used as a vehicle to provide further details regarding this functionality.

The invitation presentation module 406 can also take previously stored user preferences into account when presenting invitations. The preferences can be explicitly specified by the user or inferred based on the user's behavior and/or other sources of information about the user. For example, the user can define any aspect of the invitation delivery process, such as: the mechanism used to deliver the invitations; the placement of the invitations; the phrasing of the invitations, etc. The user can also instruct the invitation presentation module 406 to automatically invoke its message generation functionality (to be described below) without sending an invitation; the user can specify that this manner of operation applies in all circumstances or only in certain defined circumstances.

The invitation presentation module 406 can also take previous performance into account when presenting invitations. In doing so, the invitation presentation module 406 can selectively favor types (and/or manners of presentation) of invitations that have had success in eliciting responses from users.

Assume now that the user clicks on an invitation or invokes the invitation in some other way. A message formulation module 408 then comes into play by allowing a user to create a message that will be sent to one or more social network resources. Assume, to facilitate explanation, that the message formulation module 408 generates a message for dissemination to a single social network resource (although it can also send the same message to plural social network resources or different messages to different respective social network resources). In general, any information that appears in the message is regarded as message data, and this message data can originate from any source, such as the search engine 102, the result storage module 118, the user, etc.

The message formulation module 408 can rely on one or more factors in generating the message to be sent to the social network resource. In one case, the message formulation module 408 can automatically generate one or more suggested messages for consideration by the user. The message formulation module 408 can use any mechanism to make such suggestions. For example, the message formulation module 408 can use a mapping mechanism to map input factors associated with a current message-generating circumstance to an appropriate message for that circumstance.

For example, the message-generating circumstance can take into account one of more of: the triggering reason that an invitation was sent to the user; the assessed topic associated with the current search operation; the characteristics of the user; the characteristics of the contacts; information obtained from the search results; information obtained from prior responses from the contacts for on-topic (similar) subjects, and so on. The message-generating circumstance can even taken into account information obtained from previous on-topic messages sent to contacts; through this provision, the message formulation module 408 can iteratively improve the messages that it sends to the contacts over an extended search task pertaining to a defined theme.

Alternatively, or in addition, the message formulation module 408 can take into account the preferences of the user in generating a suggested message. For example, assume that a first user is mainly interested in a receiving a reply as quickly as possible, while a second user is interested in receiving a detailed reply, even though such a reply may take awhile to arrive. The message formulation module 408 can take this factor into consideration by generating a first type of message for the first user and a second type of message for the second user, where these messages are aimed at eliciting different desired behaviors from the contacts. In yet another case, a user may establish preference information which instructs the message preparation module 400 to send a pre-generated message without an express review and approval by the user; the message preparation module 400 can invoke this operation in specified circumstances.

Alternatively, or in addition, the message formulation module 408 can take into account the relative success of previous messages in eliciting responses from the contacts. Based on this consideration, the message formulation module 408 can favor message phrasing that has met with relative success. Certain practices can be identified through this mechanism. For example, in one environment, the message formulation module 408 can conclude that concise questions which end in a question mark are successful, where such questions include phrases such as “Does anyone . . . ,” “Has anyone . . . ,” “Can anyone . . . ,” etc.

Alternatively, or in addition, the message formulation module 408 can also recommend one or more social network resources that are suitable information sources to send the message to. The message formulation module 408 can apply various factors in making this decision, such as: the characteristics of the user's search operation (such as the assessed search topic); the characteristics and preferences of the user; the time and/or date; the characteristics and preferences of the contacts; the previous relative success of various social network resources in answering questions, and so on. As explained above, the message formulation module 408 can additionally or alternatively dynamically define a group of social contacts based on any criterion or criteria.

Alternatively, or in addition, the message formulation module 408 can allow a user to edit a suggested message or to input a completely new message. The user can also manually select one or more social network resources to which the message will be sent. As stated above, the message formulation module 408 can send the same message to all of the social network resources or different messages to different respective social network resources. In general, the message formulation module 408 can be configured to offer the user the ability to send a message to any social network resource with which the user has a current affiliation.

Alternatively, or in addition, the message formulation module 408 can propose plural automatically-generated messages for the consideration of the user. This might be particularly useful in those cases in which there is some ambiguity as to what message is most appropriate in a given context. The message formulation module 408 can present the plural messages in any manner, e.g., as a drop-down menu of message choices, a list that can be sequenced through by clicking “Next” or the like, etc. In one case, the message formulation module 408 can be configured to present the message that is considered most appropriate in a prominent position, e.g., at the top of a drop-down list. This most-appropriate message can serve as the default message which is presented to the user for possible revision, although the user can opt to select and edit any other message from the list.

In the above explanation, the message formulation module 408 was described as generating a textual message, e.g., by automatically suggesting such a message and/or receiving the user's manual specification of the message. In addition, or alternatively, the message formulation module 408 can generate messages having other types of content, such as image content, audio content, video content, etc. For example, the user can send an image to his or her contacts with a brief textual message that says, “Would you buy this?,” or “Do you like this?,” or “What is this?,” etc.

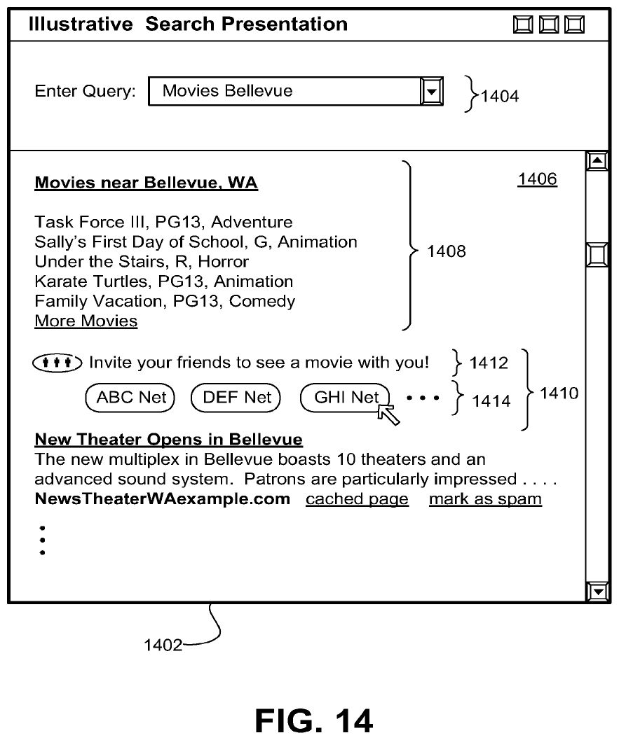

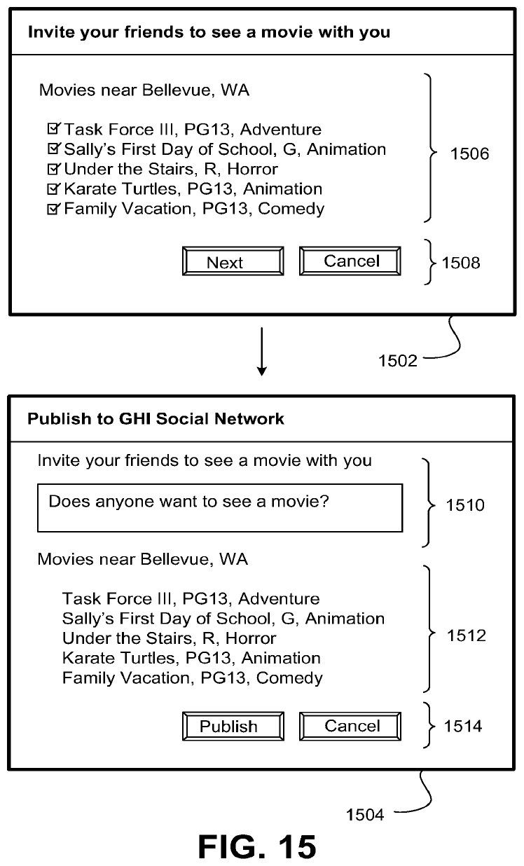

Further, the message formulation module 408 can automatically mine various sources to supplement the generated textual message. For example, assume that the user is asking a question about a particular restaurant in Bellevue, Wash. The message formulation module 408 can retrieve a map which shows the location of the restaurant and append that map (or a link to that map) to the message. Or assume that the user is asking a question about a particular movie. The message formulation module 408 can retrieve and append a trailer video for the movie or a link to such a trailer video, or a link to a movie theater, etc. The message formulation module 408 can also append possible answers to a question. For example, if the message asks, “What is a good restaurant in Bellevue?,” then the message formulation module 408 can append the top five items returned by the search engine 102, including links to each of these items. FIGS. 14 and 15, to be discussed in turn below, illustrative such a scenario. A social contact can choose among these options, or recommend a restaurant not on the list. The message can also provide a link to search results.

The message formulation module 408 can also engage the user in a dialog to create the message, e.g., using wizard-like series of interface panels or the like. This provides a structured mechanism that guides the user in creating the message, and it also provides a way to enforce practices that are considered desirable by a particular implementation of the system 100.

According to another feature, the message preparation module 400 can optionally provide any type of information which communicates a level of urgency associated with a message (e.g., a query), e.g., as conveyed by text, symbols, or other visualizations, etc. In one case, a user can manually provide this information. Alternatively, or in addition, the message preparation module 400 can rely on the above-described decision functionality to automatically assess the urgency of a query, e.g., based on the nature of the query and/or other factor(s). The decision functionality can then automatically provide information which conveys the urgency associated with a query.

Further, the message formulation module 408 can include provisions which govern how long a message (e.g., a query) is presented for review by a contact. For example, the message formulation module 408 can attach expiration information to a query. If a contact does not view and/or respond to such a query before an expiration date, the system 100 can be configured to remove that query from consideration by the contact, e.g., so that the contact can no longer view it. The system 100 can then optionally route the query to another contact (or group of contacts). This process can be repeated any number of times until, in one case, an ultimate expiration is reached (without the query being satisfactorily answered). At that time, the process can permanently remove the query from consideration. To facilitate this task, the system 100 can consult availability information regarding the current and/or future availability of contacts. This allows the message formulation module 408 to route queries to the contacts who are most likely in a position to quickly answer them. In general, this provision is useful in safeguarding the user's queries, particularly in those cases in which queries contain sensitive information. For instance, this provision limits the size of the audience that will receive a query, as well as the amount of time that a query remains active for consideration by any contact.

According to another feature, the message preparation module 400 can optionally store supplemental information about the user performing the search operation, such as the user's identity, geographical location, and so on. The message preparation module 400 can also optionally store supplemental information regarding the background context and objectives of a user's search operation, e.g., as derived from the user's present and/or past search operations, etc. The message preparation module 400 can optionally allow the user to forward this supplemental information to the contacts, along with the message (e.g., the query) itself. The supplemental information can assist the contacts in answering the user's query. To this end, the message formulation module 408 can display possible items of supplemental information to the user that the user may forward to the contacts. The user may review this list and edit it any manner (or decline to edit it). The user may then authorize the message preparation module 400 to send the supplemental information; or the user may decline to send any supplemental information.

Finally, a message forwarding module 410 sends the generated message to one or more selected social network resources. The message forwarding module 410 can send the message via any message channel, such as the network (not shown) of FIG. 1 (which may represent the Internet or other WAN, in one implementation).

In one implementation, the search engine 102 implements the base search functionality 402, the message decision module 404, and the invitation presentation module 406, while the integration module 116 implements the message formulation module 408 and the message forwarding module 410.

A.3. Functionality for Responding to Messages

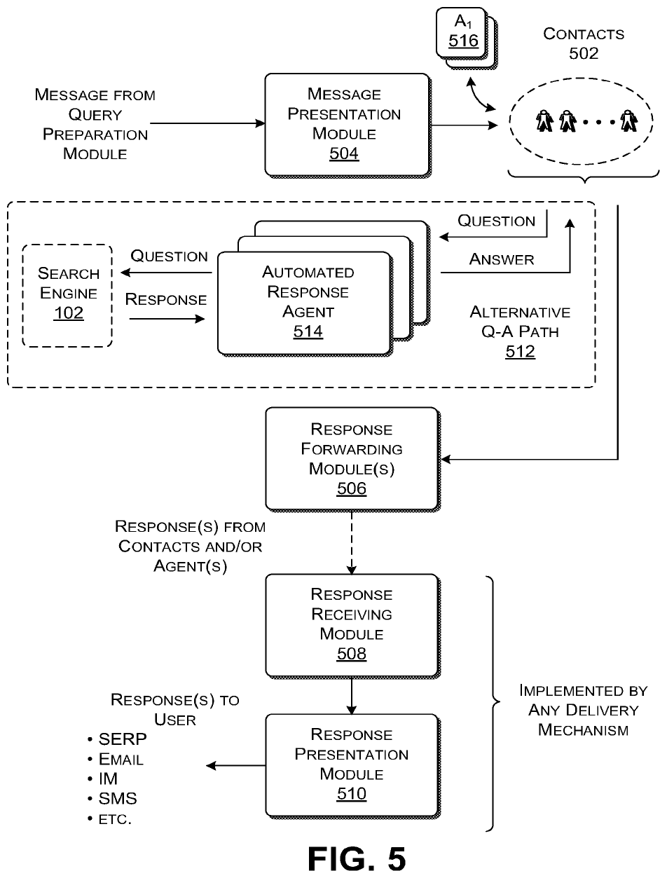

Advancing now to FIG. 5, this figure shows functionality for presenting the messages generated in the manner described above to selected contacts 502 that are associated with the social network resource. Assume, at this juncture in the description, that the contacts 502 correspond to individuals with whom a search user has a pre-established relationship. FIG. 5 also shows functionality for receiving responses from the contacts 502 and for presenting those responses to the user. The system 100 of FIG. 1 can implement the functionality of FIG. 5 in different ways. In one implementation, at least part of a social network resource (or resources) can perform the task of presenting the message to the contacts 502. Alternatively, or in addition, an entity that is working in conjunction with a social network resource can present the messages to the contacts 502. The search engine 102 and/or a client module can perform the task of receiving and presenting the contact's responses to the user.

The topmost component of FIG. 5 is a message preparation module 504. The message preparation module 504 presents the message to the contacts 502. The social network resources can present messages in different respective ways. For example, an IM social network resource can present a message as an IM message. A social network resource like Facebook or the like can present a message via a status message or some other mechanism. More specifically, in the case of profile-centric services (such as Facebook), the social network resource can present the message on the user's own page(s) and/or the contacts' respective pages. No limitation is placed on the various ways that a social network resource can communicate a message to contacts.

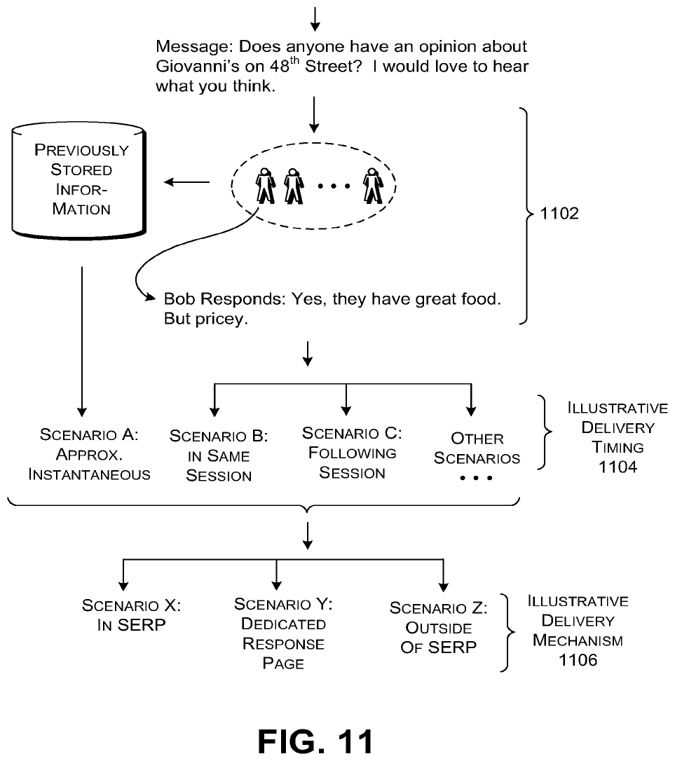

A response forwarding module 506 transfers the responses provided by at least one human contact to the user via any type of delivery mechanism, as governed by any delivery timing. FIG. 11-13 will be used as a vehicle for providing further details regarding various delivery mechanisms and delivery timings.

In general, the functionality for delivering a message includes a response receiving module 508 for receiving the responses and a response presentation module 510 for presenting the responses to the user. Presume that the response presentation module presents the response(s) within the SERP with which the user is presently interacting. In that case, the response presentation module 510 decides, based on the prevailing context, the manner in which to display the response(s) within the SERP. Once again, FIGS. 11-13 provide additional details regarding this aspect of the functionality.

The above description set forth the case in which the question originates from the user in the course of the user's interaction with the search engine 102. In addition, or alternatively, the system 100 can also facilitate integration in the “opposite direction.” In this case, a contact may present a question in the course of interaction with a social network resource. FIG. 5 represents this “opposite direction” path by the functionality enclosed in dashed lines, labeled alternative Q-A path 512. (In this case, the “contact” is actually the original question-posing user, but to maintain consistency in terminology, this individual is referred to as the “contact” below.)

In one implementation, the contact may designate one or more automated response agents (such as representative response agent 514) as automated “friends” on his or her social network resource. These types of automated resources are sometimes referred to as robots or BOTs. In operation, a contact may present a question as a status message on his or her profile page of any type. Or a contact may present a question in the course of an IM conversation, and so on. The contact can formulate the question as a natural language query, or as one or more key terms, or in some other form or combination of forms. One or more response agents may be configured to monitor the messages being authored by the contact. The response agents operate by: (a) determining whether a message is a question; and, if so, (b) attempting to automatically answer the question.

More specifically, consider the operation of the response agents from the perspective of the representative response agent 514. The response agent 514 can determine that a message pertains to a question by performing natural language processing; for instance, in one case, the response agent 514 can determine that a message is a question because it ends in a question mark and/or because it contains keywords commonly found in questions (e.g., “Who,” “What,” “When,” “Does anyone,” “Why,” etc.). After determining that the message is a question, the response agent 514 can then route the question to the search engine 102 and/or some other analysis tool(s). In performing its operation, the response agent 514 can optionally access information maintained by the social network resource, such as information that can be gleaned from the profiles of the human contacts 502. This allows the response agent 514 to more readily interpret the question, and thus allows it to pass relevant contextual information to the search engine 102, which, in turn, allows the search engine 102 to potentially provide a more relevant answer.

Consider the following example. Assume that the contact submits a question such as “What do you recommend I read while on vacation?” as a status message on his or her profile page of a social network resource. The response agent 514 can intercept this message, detect that it pertains to a question about books, and retrieve a New York Times best seller list for dissemination to the contact. The response agent 514 can perform this task by consulting the search engine 102 and/or some other analysis tool.

According to another optional feature, a contact may authorize one or more automated answering agents to assist in responding to a user's query, such as representative answering agent (Ai) 516. In one case, an answering agent automatically responds to a question, thus acting as a real-time social actor. In another case, an answering agent can provide a draft response for the review of the contact. The contact may edit the draft response in any manner and then send it to the user. The contact may subscribe to any such answering agents and/or create new answering agents. Each answering agent may exhibit behavior which is fully customizable by an individual contact. This enables the answering agent to act as an assistant to the human contact.

The answering agent can be configured to provide automated (and/or proposed) responses for certain types of queries. The answering agent can assess the nature of a query based on any factor or combination of factors, such as the characteristics of the query, the characteristics of the user making the query, and so on. The answering agent can formulate an automated response based on any factor or combination of factors, such as the characteristics of the query, previously generated responses, and so on. For example, the answering agent can compose a response by selecting from among previously constructed templates. The answering agent can customize one of these templates when answering a query, e.g., based on late-breaking, instance-specific information obtained from the query and/or related background information, etc.

For example, an expert contact in recreational activities in a region may wish to construct a set of answers that he only reveals in response to questions from friends or others with whom he has a specific relationship with on a social network. In response to a query from such a user, the answering agent may select one of the expert's pre-constructed answers that is deemed appropriate to answer the query; then, the answering agent can automatically custom-tailor the answer based on multiple sources of information, including the given or inferred age, gender, interests, and demographics of the user performing the search. In addition, or alternatively, the answering agent can customize the answer based on other contextual information, such as the current season or month, the current or forthcoming weather, current events (e.g., as drawn from online event catalog which describes scheduled recreational events, etc.). Through this provision, expert contacts are provided with a means of re-using prior answers or answers drafted in advance of submitted queries. Through this process, an expert contact may build a social answering service based on their expertise.

A.4. Illustrative Variations

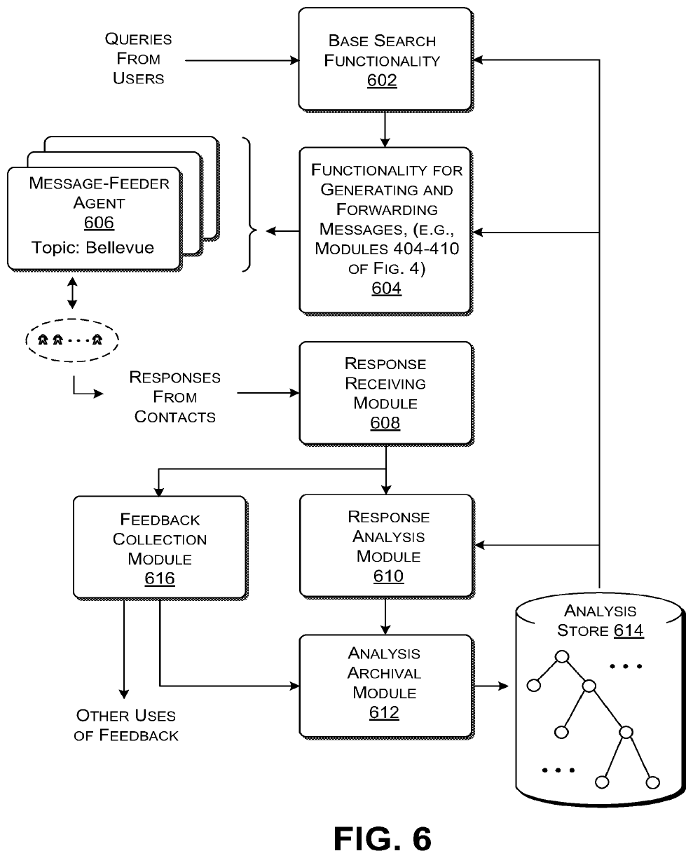

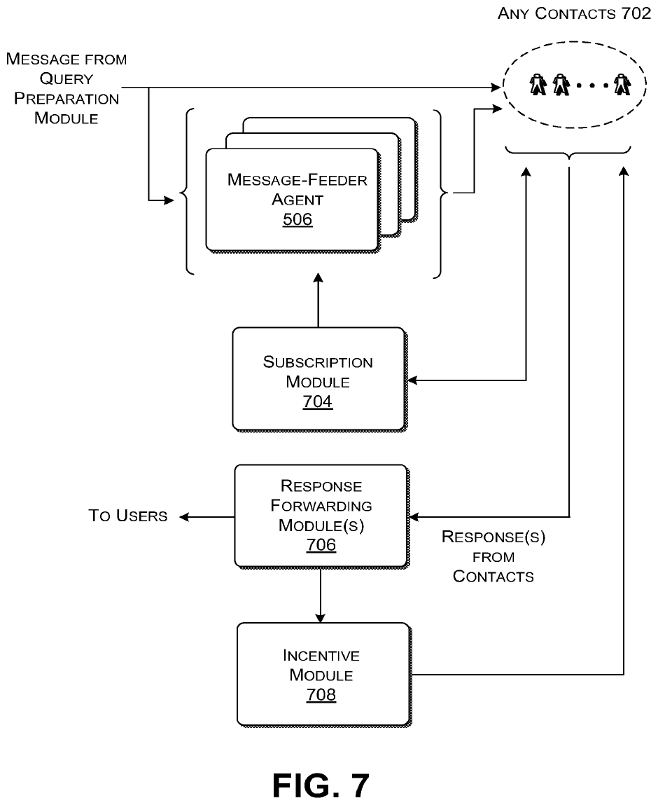

FIGS. 6 and 7 describe additional features that can supplement the system 100 described above. By way of overview, FIG. 6 shows functionality for disseminating messages to one or more message-feeder agents. Contacts, who may have no pre-established relationship with users who are performing searches, can subscribe to these message-feeder agents. The contacts receive messages from these message-feeder agents and provide responses in the manner described above. FIG. 6 also describes functionality for analyzing and evaluating responses received from the contacts. The functionality uses this analysis and evaluation to improve various aspects of the operation of the system 100. FIG. 7 describes complementary functionality that enables the contacts to interact with the message-feeder agents.

Beginning with FIG. 6, this figure shows base search functionality 602 for performing the same role as the base search functionality 402 of FIG. 4. Namely, the base search functionality 602 receives queries from users and returns search results which satisfy the queries.

FIG. 6 also shows functionality 604 which carries out the operations of modules 404-410 of FIG. 4. Namely, this functionality 604 determines whether a user's search operation warrants interaction with a social network resource. If so, the functionality 604 may send an invitation to the user, compose a message, and send the message to the social network resource. Alternatively, the functionality 604 can omit one or more of the functions attributed to the modules 404-410. For instance, the functionality 604 can immediately send a message to the social network resource after it determines that the search operation warrants interaction with the social network resource, e.g., without providing an invitation to the user and without giving the user an opportunity to compose the message.

In the context of FIG. 6, however, the functionality 604 can forward the message to the social network resource via one or more message-feeder agents, such as illustrative message-feeder agent 606. Each message-feeder agent 606 is assigned to a respective topic of interest. For example, a first group of message-feeder agents may correspond to different respective locations, such as different respective cities. Other message-feeder agents may correspond to respective hobbies. Other message feeder agents may correspond to respective news-related topics, and so on. No limitation is placed on the association between a message-feeder agent and a corresponding topic. The message-feeder agents can be implemented in any manner, such as by one or more server computers and associated data stores.

The functionality 604 operates by first detecting that a search operation corresponds to a topic that is, in turn, associated with a particular message-feeder agent. The functionality 604 can perform this task by analyzing terms in a search query in the manner described above, e.g., by mapping the terms to associated topics using exact and/or fuzzy matching rules. For example, assume that the user inputs the search query “trails in Seattle.” The functionality 604 can determine that the term “trails” maps to a topic of “hiking,” and the term “Seattle” maps to a topic of the same name (i.e., “Seattle”). The functionality 604 can then route the raw search query entered by the user to one or more associated message-feeder agents, such as a first message-feeder agent assigned to the topic of hiking and a second message-feeder agent assigned to the topic of Seattle. Alternatively, or in addition, the functionality 604 can allow the user to compose a message to be sent to these message-feeder agents. The message is related to the raw search query, as opposed to the raw search query itself. In a manner to be described below with respect to FIG. 7, contacts which subscribe to appropriate message-feeder agents can peruse the messages forwarded to these agents. The contacts may then choose to respond to one or more of the messages.

A response receiving module 608 receives the responses from the contacts and forwards the responses to the user. The responses can be paired with their respective invoking queries to form query-response pairs. The response receiving module 608 can also forward the query-response pairs to a response analysis module 610. The response analysis module 610 can perform any type of analysis on the query-response pairs. For example, the response analysis module 610 can examine the terms in the responses and queries to classify the nature of the responses. For example, assume that the user inputs the query, “restaurants Bellevue,” upon which the user receives the response “Try Giovanni's on 48^{th} Street.” The response analysis module 610 can classify this query-response pair into various categories, such as, from broad to narrow: restaurants; Italian restaurants; Bellevue Italian restaurants; and/or the particular restaurant Giovanni's, and so on. The response analysis module 610 can also assign the query-response pair to various “parallel” or “sister” categories, such as “Bellevue.”

An analysis archival module 612 can store the conclusions of the response analysis module 610 in an analysis store 614. In one case, the response analysis module 610 can form an ontology that comprises a hierarchical taxonomy of topics. The response analysis module 610 can store particular query-response instances within such a hierarchy, as well as conclusions reached on the basis of such query-response instances.

The functionality of FIG. 6 can also include a feedback collection module 616. The feedback collection module 616 allows recipient users to grade or rate responses received from contacts. The feedback collection module 616 can allow users to evaluate responses in any manner, e.g., by providing a score on a scale of 1 to 5, or by providing a more simple thumbs up or thumbs down rating, etc. Users can also flag responses which appear to be spam-like or otherwise abusive. A user's rating may reflect the user's immediate evaluation of a response; in addition, or alternatively, a user may enter an evaluation after investigating the information imparted in a response, e.g., in the above scenario, after visiting the restaurant Giovanni's. The analysis archival module 612 can store the users' evaluations in the analysis store 614. Note that the feedback collection module 616 is described in the context of functionality that uses message-feeder agents, but the feedback collection module 616 can also be used in systems which omit these agents.

The functionality of FIG. 6 can uses the information in the analysis store 614 for a variety of purposes. In one case, the base search functionality 602 can use the information to improve the quality of the search results which it provides to the user. In one case, for instance, the base search functionality 602 can extract search results from the information in the analysis store 614; in addition, or alternatively, the base search functionality 602 can use the information in the analysis store 614 to weight the relevancy of the search results which it obtains from other sources. In addition, or alternatively, the functionality 604 can use the information in the analysis store 614 to improve any aspect of its operation, such as the generation of invitations, the composition of messages, the routing of messages to message-feeder agents, and so on.

FIG. 7 complements FIG. 6 by showing how a group of contacts 702 respond to messages. The contacts 702 may or may not have a pre-established relationship with the users who are performing the searches. In one case, the functionality of FIG. 6 directly forwards the messages to the contacts 702. Alternatively, or in addition, the functionality of FIG. 6 forwards the messages to the contacts 702 via appropriate message-feeder agents, such as illustrative message-feeder agent 606.

A contact may gain access to a particular message-feeder agent by “signing up” to such an agent through a subscription module 704. In one case, a social network resource administers the subscription module 704. In this case, the contact may visit the social network resource to view of collection of available topics associated with respective message-feeder agents, e.g., as presented by a page which provides a list, or a drop-down list, or some other mechanism. The subscription module 704 allows the user to subscribe to one or more of these message-feeder agents, e.g., by allowing the user to click on desired agents in the list.

After subscribing to the desired message-feeder agents, the contact can examine the messages being posted to these agents. In one case, a message-feeder agent presents the messages as a moving stream of such messages, where the agent is configured to direct the user's attention on the most recent message in the stream. As stated, the messages may correspond to raw search queries or content that is composed based on the search queries. The contact may then enter responses to these messages in any manner previously described, such as by typing in responses to these messages. A response forwarding module 706 forwards the responses to the users.

An incentive module 708 can optionally reward the contacts for responding to the messages in any manner. In one non-limiting example, the incentive module 708 can award a prescribed number of points when a user enters a response. The incentive module 708 can maintain records to keep track of, at any given time, how many points each contact has accumulated. A contact may redeem his or her points for any type of reward, such as cash, prizes, entitlements, etc. The incentive module 708 can also accept feedback received from users, e.g., as collected by the feedback collection module 616 of FIG. 6; the incentive module 708 can use this feedback information to influence the rewards it confers to contacts.

In one case, the message-feeder agents conceal the identities of the participants of the system. For example, the contacts may not be aware of the identities of the users who have generated the search queries. Likewise, the users who generate the search queries may be unaware of the identities of the contacts who have submitted responses. In other words, the message-feeder agents render the interaction between users and contacts anonymous in both directions. Alternatively, or in addition, the users may opt to reveal their identities to all contacts or only a subset of contacts that meet a prescribed criterion or prescribed criteria. Contacts may likewise reveal their identities to all users or to users who meet a prescribed criterion or prescribed criteria.

A.5. Functionality for Implementing Modules

FIG. 8 shows functionality 802 for implementing any individual module in FIGS. 4-7. A first type of functionality 804 can implement any type of automated analysis module 806 in conjunction with an associated data store 808. The analysis module 806 can be implemented, for example, as a machine learning engine of any type (e.g., employing Bayesian analysis, regression analysis, hidden Markov analysis, etc.), a rules-based engine (e.g., employing artificial intelligence, etc.), a lookup table mechanism, a language processing engine, etc., or any combination thereof. The data store 808 can maintain appropriate data that complements the operation of the analysis module 806; the data may include statistical weights for a model, rules, mapping tables, etc.

A second type of functionality 810 can implement any type of preference setting module 812 in conjunction with an associated data store 814. The preference setting module 812 can obtain preference information regarding the preferences and/or characteristics of the user in any fashion. In one case, for example, the preference setting module 812 can record the preferences defined by a user in an explicit fashion. In another case, the preference setting module 812 can infer the preferences and characteristics of the user in an indirect fashion, e.g., based on the behavior of the user. The data store 814 can maintain the preference information. A similar type of information-collecting (or information-inferring) module and associated data store can be used to collect information about the social network resources, contacts, etc.

The system 100 as a whole can maintain private data regarding the user in a secure fashion, preventing its dissemination to unauthorized entities. Further, the system 100 can allow the user to expressly opt in or opt out of its question-posing services. Further, the system 100 can allow the user to maintain control over the manner in which the personal data is used and retained, etc.

A.6. Illustrative Graphical User Interface Presentations and Illustrative Examples

FIGS. 9-15 show various illustrative graphical user interface (UI) presentations that the system 100 can supply to the user for interaction with the system 100. In general, the graphical UI presentations shown in FIGS. 9-15 adopt a representative selection and arrangement of UI features intended to facilitate explanation of the principles described herein. Other graphical UI presentations can adopt other selections and arrangements of features. Further, other graphical UI presentations can adopt different “looks and feels” compared to the graphical UI presentations shown in FIGS. 9-15. In short, these graphical UI presentations are non-limiting examples and should be construed accordingly.

FIG. 9 shows a page 902 provided by the search engine 102, indicating the manner in which the message preparation module 400 can invite the user to interact with a social network resource. In this example, assume that a user is interested in finding a good Italian restaurant in Bellevue, Wash. The user may enter the search query “Italian Restaurants” or the like into a search box 904 of a query area 906 of the page 902. The search engine 102 responds by presents search results 908. The search results 908 include a list of items that match the search query. In conventional manner, the items may include links to associated network-accessible resources (e.g., pages, documents, etc.) and text snippets associated with the resources. The search engine 102 can detect the location of the user in a known manner, e.g., based on the IP address of the user's computer, etc. Hence, the search results include items pertinent to Bellevue, Wash., even though the user did not expressly identify this location.

The decision module 404 examines the current search operation in the manner described above using any type of technique or combination of techniques. For example, the user's current search query (“Italian Restaurants”) is one source of information which manifests the user's search-related objectives; but the objectives of the user can also be inferred based on previous queries submitted by the user, the user's characteristics, and other factors. Assume that the decision module 404 concludes that the current search operation warrants interaction with a social network resource. If so, the invitation presentation module 406 can provide one or more invitations to the user which invite the user to interact with a social network resource. To facilitate explanation, FIG. 9 shows several such invitations (910, 912, 914, 916) dispersed at different locations on the page 902. This is one of many possible scenarios; in other cases, the invitation presentation module 406 may send just a single invitation.

Generally, in generating an invitation, the invitation presentation module 406 can retrieve a stock message from a store of possible messages based on various contextual factors. As explained above, some of the possible messages can include blank text fields that can be filled in to suit a particular circumstance. For example, a stock message might read, “Ask your friends about <topic> in <location>.” The invitation presentation module 406 can identify the topic and location in the manner described above and then substitute this information into the “topic” field and “location” field of the stock message.

Generally, one or more stock messages constitute template information for a particular theme. For example, one theme may pertain to shopping, another theme may pertain to restaurant and movie reviews, etc. In one implementation, groups of users can edit template information, author new template information, share template information, etc.

In a first example, the message preparation module 400 can assume that the user is interested in finding any suitable local Italian restaurant, as opposed to investigating a particular Italian restaurant. Based on this assumption, the invitation presentation module 406 can generate an invitation having a restaurant-agnostic phrasing. The invitation presentation module 406 presents this message at a location befitting its level of generality. For example, the invitation presentation module 406 can present the general-purpose invitation 910 in the query area 906 or some other overview section of the page 902. The invitation 910 states “Ask your friends about restaurants in Bellevue!” or the like.

In a second example, the message preparation module 400 can assume that the user is interested in investigating a particular restaurant. Based on this assumption, the invitation presentation module 406 can generate an invitation having a more targeted phrasing (compared to the phrasing of invitation 910); furthermore, the invitation presentation module 406 can present this message at a location befitting its level of specificity. For example, the invitation presentation module 406 presents invitations 912 and 914 embedded within the search results 908, as these invitations pertain to particular restaurants identified by the search results 908. The phrasing of these messages reads, “Ask your friends if they like this restaurant!,” or more specifically, for one item in the search results, “Ask you friends if they like Giovanni's restaurant,” etc.

In a third example, the message preparation module 400 can assume that the user may be having difficulty retrieving desired search results (based on any of the factors described above). Based on this assumption, the invitation presentation module 406 can generate an invitation that addresses the user's potential failure; furthermore, the invitation presentation module 406 can present this message at a location that the user is likely to encounter (or actively seek out) upon having search difficulties. For example, the invitation presentation module 406 places an invitation 916 at the end-of-list area 918 of the page 902, based on the assumption that a user who reaches the end of the list may not have found an item that satisfies his or her search objectives. Alternatively, the invitation presentation module 406 can present the invitation 916 at a location at which the page 902 typically offers alternative queries to the user (not shown). The invitation 916 reads, “Didn't find what you need? Ask your friends!” or the like.

In summary, the invitation presentation module 406 can present any number of invitations, can present the invitations at various locations on the page 902, and can adopt any phrasing and formatting for the invitations. Alternatively, the invitation presentation module 406 can display the invitations using a mechanism outside the context of the page 902, such as using an IM mechanism or the like. Alternatively, the message preparation module 400 can entirely omit the forwarding of invitations.

In the present examples, the invitations (910, 912, 914, 916) are associated with hypertext links. Upon activation of one of these invitations, the message preparation module 400 can invoke another graphical UI presentation that allows the user, in interactive fashion, to generate the message that will be sent to one or more social network resources. Presume, for the purposes of the explanation, that the user clicks on the invitation 912 that is associated with an Italian restaurant named Giovanni's.

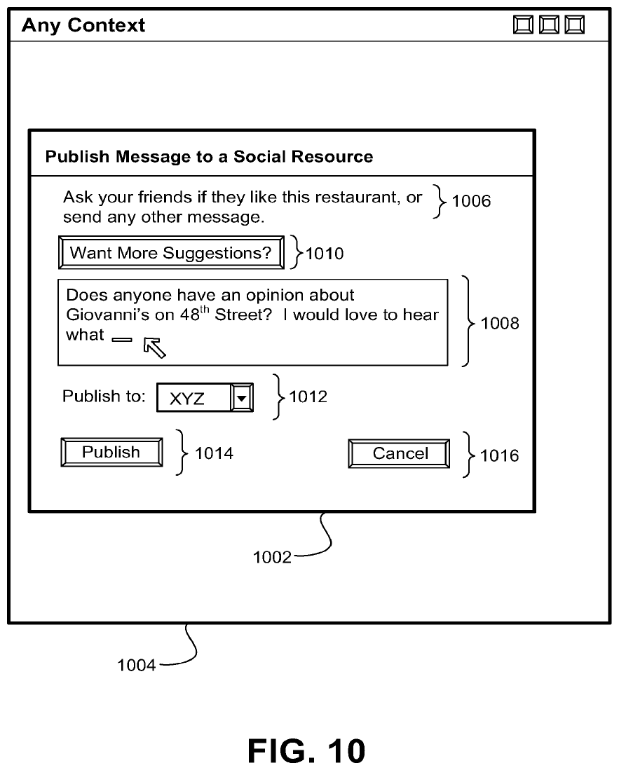

In one case, the message formulation module 408 responds to the user's selection by displaying a type of interface 1002 shown in FIG. 10. The message formulation module 408 can display the interface 1002 in any context 1004, such as in the context of a search page, a social network page, etc. The interface 1002 may comprise a dialog box (or a series of such boxes) which presents information to the user and solicits information from the user. The individual features of the interface 1002 represent one of many ways by which a user may interact with the message formulation module 408 to generate a message.

The interface 1002 can include introductory text 1006 which explains the purpose of the interaction functionality that is being invoked. The interface 1002 can also optionally present a suggested default phrase in an editable region 1008. As explained above, the message formulation module 408 can prepare a contextually appropriate default message. For example, here, the user wants to discover information regarding a particular restaurant, Giovanni's. Hence, an appropriate message might read, “Has anybody been to Giovanni's on 48^{th} Street? Did you like it?” Here, the message formulation module 408 can modify the default message by substituting text into empty text fields, e.g., by filling in the name of the restaurant (“Giovanni's) and the address of the restaurant (“48^{th} Street). The message formulation module 408 can draw from multiple sources in filling in the text fields of a default message, such as the search query, the search results, supplemental information (e.g., map information), and so on. Further, the message formulation module 408 can optionally append supplemental information to a message, such a map, a link to a page about the restaurants, etc.

The editable region 1008 is configured to allow the user to change the default message in any manner. Indeed, the user can create an entirely new message if he or she so chooses. Here, the user has changed the second sentence of the message to read, “I would love to hear what you think.”

In some circumstances, there may be some ambiguity regarding the appropriateness of different possible default messages. To address this situation, a command 1010 allows the user to view different possible default messages. Upon selection of an alternative default phrase, the message formulation module 408 can present that default phrase in the editable region 1008. This is one of many control interfaces that can be used to generate a message.

Another command 1012 allows the user to select the social network resource (or resources) that will receive the message. At the outset, the message formulation module 408 can present a recommended social network resource (or resource) based on the factors described above. The command 1012 can also allow the user to change the default selections in any manner, e.g., by selecting a different social network resource, by selecting additional social network resources, etc.

Another command 1014 instructs the message forwarding module 410 to transmit the generated message to the social network resource(s). Another command 1016 allows the user to cancel the interface 1002 without sending a message.

In yet another alternative implementation, in certain circumstances, the message preparation module 400 can automatically send messages to a social network resource without sending an invitation to the user and/or without interacting with the user to customize the messages. For example, the user can set preference information which instructs the message preparation module to automatically send a default message when the user places an item in her shopping cart, or performs some other telltale action. In these cases, the user is saying, in effect, that she unconditionally wishes to solicit the advice of her friends before she buys a product.

FIG. 11 presents an overview that describes how the social network resource (mentioned in the singular below to facilitate explanation) handles the message. FIG. 11 also illustrates how the responses collected from the social network resource are routed back to the user and presented to the user.

As indicated in section 1102, the social network resource receives the message and presents it to the human contacts in an appropriate manner. For example, if the social network resource is an IM social network resource, it will present the message as an IM message. If the social network resource maintains profiles of users (e.g., as in the Facebook example), it can present the message in one of the pages associated with the originating user and/or the recipient contacts. In addition, or alternatively, the contacts can receive the message by accessing one or more message-feeder agents to which they subscribe.

A human contact can provide a response to the message in an appropriate manner. Assume in this case that a friend, Bob, responds, “Yes, they have great food. But pricey.” In addition, or alternatively, a social network resource can mine pre-stored information that is already available at the social network resource and fashion a response based on this information. For example, a user Frank may maintain a profile which indicates that he enjoys Italian restaurants in the Seattle region, or that he specifically recommends the restaurant Giovanni's. In addition, or alternatively, the user Frank may have previously answered a question regarding the restaurant Giovanni's. The social network resource can examine this type of pre-stored information and present a response to the user that is formulated based on this information. In the example presented above, the social network resource can provide a response that says, “Please note that Frank lists Giovanni's as one of his top 10 restaurants in Bellevue?” The message can also provide an interface by which the user may contact Frank. In addition, or alternatively, a social network resource can examine a more encompassing database of queries and responses to fashion an automatic response, where such a database can encompass information from a larger group of individuals (e.g., not limited to the user's own contacts). Such a database is akin to (or the same as) the information maintained by the analysis store 614 of FIG. 6.

The above automated response functionality (which delivers an automatic response based on pre-stored information) accommodates a number of different modes of operation. In one case, the system 100 can invoke the automatic response functionality when a user expressly activates an invitation and composes a message. In another case, the system 100 can invoke the automatic response functionality in direct response to the user's submission of a search query (or, more generally, in response to the user's ongoing search operation). That is, in this scenario, the user may receive an automated reply within the SERP (and/or elsewhere) without activating an invitation. The automated response in this case can be based on the user's search query and/or other information that is derived from the search operation. In any of these scenarios, the system 100 can send a message to both the automated response functionality and the human contacts, or just the automated response functionality, or just the human contacts.

Section 1104 indicates that the system 100 can provide the response to the user using different delivering timings. In scenario A, the system 100 provides information that is mined from pre-stored information maintained by a social network resource (or elsewhere). Since the system 100 can provide this information without waiting for an actual human to respond to the message, it can provide a response soon after the message is presented to the social network resource (such that, in one case, a user may perceive the response as arriving very quickly after the message is submitted). In scenario B, the system 100 provides a response to the message in the same search session in which the message was sent. In scenario C, the system 100 provides the response following the session in which the message was sent. These delivery timing scenarios are representative, rather than exhaustive of the full range of possibilities.

Section 1106 indicates that the system 100 can provide the response using different delivery mechanisms. In scenario X, the system 100 presents the response in a search engine result page (SERP). In scenario Y, the system 100 presents the response in a dedicated search response page of any type. In scenario Z, the system 100 presents the response using some mechanism that is outside the context of a SERP or dedicated search response page.

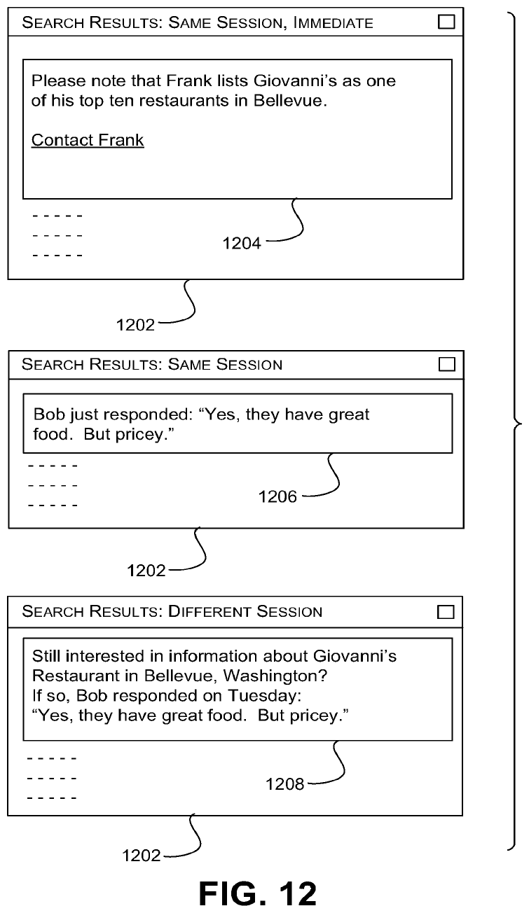

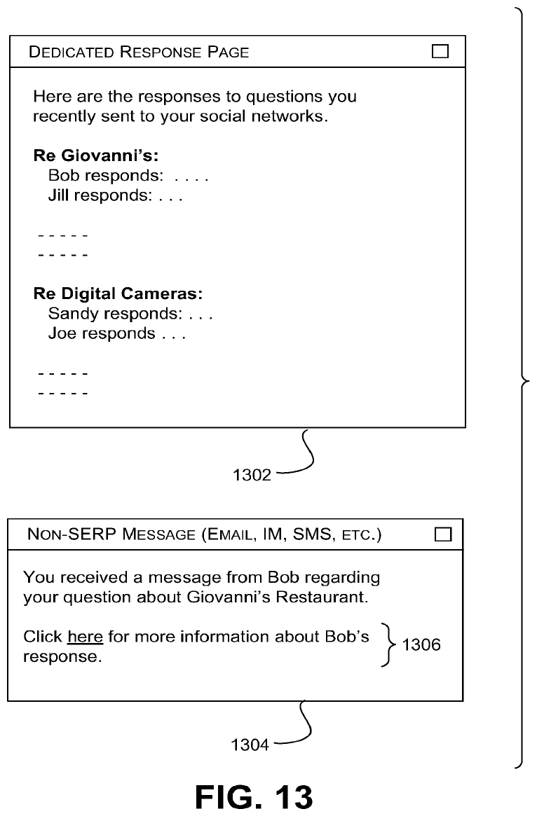

FIGS. 12 and 13 provide examples of different types of delivery timings and delivery mechanisms. Starting with FIG. 12, this figure shows three cases in which a response is presented within a SERP 1202, where the SERP 1202 mixes together search results from the search engine 102 and responses from the user's contacts. In a first case, a response 1204 is presented soon after the user submits the message or a message is otherwise submitted. The response 1204 is based on pre-stored information available to the social network resource. In this scenario, the triggering message may or may not have been generated in response to the express invocation of an invitation by the user; further, the message may or may not have also been submitted to human contacts. In a second case, a response 1206 is presented in the same search session in which the message was sent. In a third case, a response 1208 is presented in a different search session compared to the session in which the message was sent.

The placement, formatting, and introductory phrasing of the responses can differ based on the different contexts in which the responses are provided. For example, the same-session response 1206 can be presented within the search results or at some other appropriate location on the page that correlates with the focus of the user's present interest. The different-session response 1208 can be presented in some type of overview section of the SERP 1202, such as at the top of the SERP 1202. The different-session response 1208 can also include introductory text which provides some background information regarding the message; this is useful because the question corresponding to the response may not be fresh in the user's mind.

For the particular case of a delayed delivery of a response (e.g., as in the case of the response 1208), the system 100 can use different rules to present the response. In one case, the system 100 can present the response regardless of what type of search related-task that the user is engaged in at the moment. For instance, the system 100 can present the response as soon as the user logs into the search engine 102 (where the user can be identified based on account information that he or she enters, etc.). In another case, the system 100 can present the response only if it determines that the response pertains to a topic that is not time-dependent. For example, the system 100 may present an out-of-session response that pertains to literature, but not one that pertains to a question about the current weather. In another case, the system 100 can present the response when it determines that the user is now conducting a search operation that is related to the original search operation (at which time the message was sent to the social network resource). Still other presentation rules are possible. In any of these cases, the user can provide preference information which influences the presentation of out-of-session responses like response 1208.

FIG. 13 shows a dedicated response page 1302 for presenting responses to the user. This dedicated response page 1302 accumulates responses to messages sent by the user, e.g., within a prescribed period of time. (The dedicated response page 1302 can also provide archival access to older responses). The user can activate any individual response within the dedicated response page 1302 to retrieve additional information regarding that response.

FIG. 13 also shows a non-SERP mechanism that can be used to display or present responses, such as an Email delivery mechanism, an IM delivery mechanism, etc. FIG. 13 shows a page 1304 associated with one such non-SERP mechanism. That page 1304 may provide contextual information which explains the origin and purpose of the message. The page 1304 may also provide a link 1306 or the like which allows the user to retrieve additional information regarding the response.

Still other delivery timings and delivery mechanisms are possible. For example, the system 100 can present responses in audio form, video form, etc.

FIG. 14 shows another page 1402 provided by the search engine 102, indicating another manner in which the message preparation module 400 can invite the user to interact with a social network resource. In this example, assume that a user is interested in finding a movie to see in Bellevue, Wash. The user may enter the search query “Movies Bellevue” or the like into a search box 1404 of a query area of the page 1402. The search engine 102 responds by presenting search results 1406. The search results 1406 include a list of items that match the search query. A first item 1408 corresponds to an instant answer type of search result. This item identifies five hypothetical movie titles that are being presented in Bellevue, Wash. or the vicinity.

Assume that the decision module 404 concludes that the item 1408 warrants interaction with a social network resource. If so, the invitation presentation module 406 can provide an invitation 1410 to the user which invites the user to contact a social network resource. More specifically, the invitation 1410 includes a text portion 1412 which conveys an invitation message. The invitation 1410 also includes a group of options 1414 that identifies different respective selectable social network resources, e.g., the generically-labeled ABC network, DEF network, GHI network, etc. Assume that the user clicks on the icon associated with the GHI network, which prompts the system 100 to share a message with the GHI network.

FIG. 15 shows two interfaces (1502, 1504), presented in sequence, which allow a user to compose a message after selecting the GHI network. Namely, the first interface 1502 displays a list 1506 of movies obtained from the search results (of FIG. 14). The integration module 116 can cull this list in the manner described above, e.g., by performing a background follow-up search using the search engine 102, or by accessing pre-stored information maintained in the result storage module 118. The list 1506 includes check boxes or the like which allows the user to select the movie titles that will be included in the message being composed. The interface 1502 includes commands 1508 that allow the user to advance to the next interface 1504 (“Next”) or cancel the message-creation operation (“Cancel”).

If “Next” is invoked, the second interface 1504 is displayed. The interface 1504 includes a message box 1510 which provides a suggested message and/or allows the user to create (or edit) a message. Here, the user has composed a message that reads, “Does anyone want to see a movie?” The interface 1504 also includes a list 1512 of movies that the user has selected via the first interface 1502. The interface 1504 includes commands 1514 that allow the user to publish the composed message (“Publish”) or cancel the message-creation operation (“Cancel”). The message that is composed will include the text “Does anyone want to see a movie?,” along with the list of movies shown in the interface 1504. FIGS. 14 and 15 therefore represent the case in which the message has multiple components—in this example, a text message and a list of options. The interfaces (1502, 1504) allow the user to compose the message by effectively filling in a form in a structured manner.

The paradigm shown in FIGS. 14 and 15 can be extended to other scenarios. For example, the user may enter a search query that identifies a particular movie. The system 100 can respond by displaying a list of theaters which are showing this movie in Bellevue, Wash. The system 100 can compose a message which includes these theater locations in the manner described above. The system 100 can also display a map of an identified location and give the user the option of appending that map to the message that is sent to the social network resource. The system 100 can also allow the user to compose a message which includes plural movie playing time options.

B. Illustrative Processes

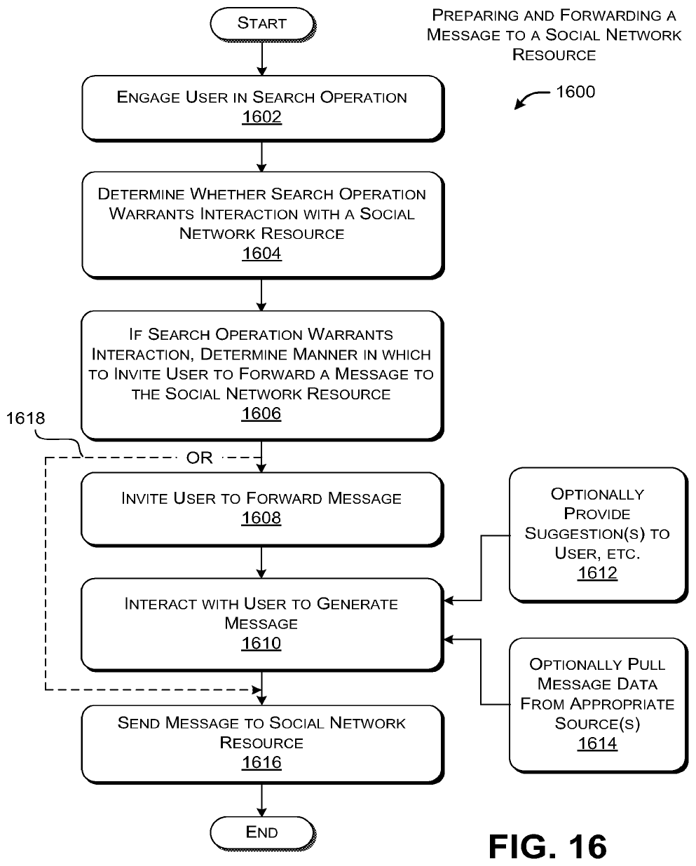

FIGS. 16-23 show procedures that explain one manner of operation of the system 100 of FIG. 1. Since the principles underlying the operation of the system 100 have already been described in Section A, certain operations will be addressed in summary fashion in this section.

Starting with FIG. 16, this figure shows a procedure 1600 for preparing and forwarding a message to a social network resource (or resources). To facilitate explanation, FIG. 16 will be described from the perspective of the message preparation module 400 which prepares a message for transmission to a single social network resource.

In block 1602, the message preparation module 400 engages the user in a search operation, which involves receiving a user's search query. The message preparation module 400 can also receive other information that has a bearing on the user's prevailing search operation, as described above.

In block 1604, the message preparation module 400 determines whether the user's search operation warrants interaction with a social network resource. The message preparation module 400 can take into consideration any one or more of the factors described above in reaching this conclusion.

In block 1606, if interaction is deemed warranted, the message preparation module 400 determines the manner in which it will present an invitation (or invitations) to the user. Block 1606 may involve determining where to present the invitation (and through what delivery mechanism to present the invitation). It may also involve determining the phrasings of the invitation, and so on.

In block 1608, the message preparation module 400 presents the invitation to the user in the manner determined in block 1606. Presume here that the user clicks on or otherwise activates the invitation.

In block 1610, the message preparation module 400 interacts with the user to generate the message to be sent to the social network resource. This interaction may determine the phrasing of the message, the social network resource(s) that will receive the message, and so on. Block 1612 indicates that the interaction in block 1610 may additionally involve providing message suggestions to the user. Block 1614 indicates that the integration module 116 can optionally pull message data from various sources in the course of composing the message, e.g., from the search engine 102, and/or from the result storage module 118.

In block 1616, the message preparation module 400 sends the generated message to the user.

Dashed line 1618 indicates that the message preparation module 400 may alternatively omit block 1608 and/or block 1610. In this case, the message preparation module 400 can directly send a message to the social network resource without notifying the user and without interacting with the user. This alternative behavior can be fully customizable by the user and can be invoked in selected circumstances.

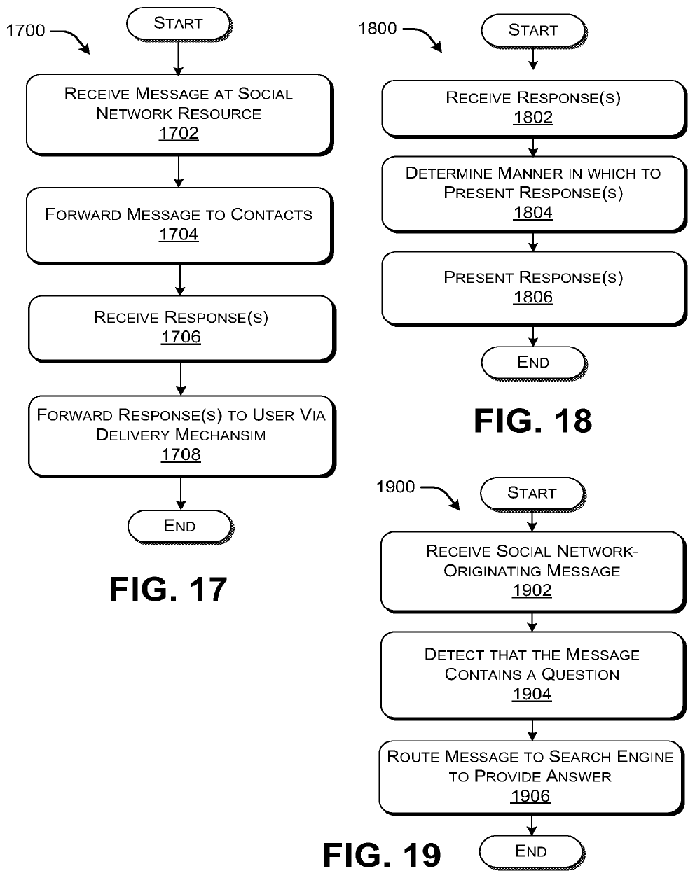

FIG. 17 shows a procedure 1700 for receiving and processing the message. This procedure 1700 can be implemented by the social network resource, in possible conjunction with other functionality.

In block 1702, the social network resource receives the message generated as per the procedure of FIG. 16.

In block 1704, the social network resource forwards the message to the contacts in the manner described above. The manner in which the message is presented will depend on the nature of the social network resource.

In block 1706, the social network resource potentially receives responses from the human contacts.

In block 1708, the social network resource forwards the received responses to the user via any delivery timing and any delivery mechanism.

FIG. 18 shows a procedure 1800 for receiving responses provided as per the procedure of FIG. 17. The procedure 1800 can be implemented by the search engine 102 and/or by aspects of a client module and/or by other functionality.

In block 1802, the system 100 receives the responses.

In block 1804, the system 100 determines the manner in which the responses will be conveyed to the user. This block may involve deciding: where to present the responses within a particular delivery mechanism; when to present the responses; what text to display so as to introduce the responses to the user, etc.

In block 1806, the system 100 presents the responses to the user in the manner determined in block 1804.

FIG. 19 shows a procedure 1900 for integrating the search engine 102 and a social network resource in the “opposite direction” compared to that described above. In this case, the question originates from the social network resource, rather than the search engine 102. This procedure 1900 will be explained from the perspective of the representative automated response agent 514 of FIG. 5.

In block 1902, the response agent 514 receives a social network-originating message from a message author. This message is generated in the course of the author's interaction with the social network resource.

In block 1904, the response agent 514 detects that the message contains a question.

In block 1906, the response agent 514 routes the message to the search engine 102 (and/or other analysis tools) to provide an answer to the question presented in the message. The system 100 can optionally use information extracted from the social network resource to supplement the message. The extracted information can include information regarding the characteristics of the author (e.g., obtained from the author's profile), information regarding the author's contacts, information regarding the prior behavior of the author (e.g., information regarding prior messages and responses attributed to the author), and so on. The extracted information can supply contextual information which potentially enables the search engine 102 to provide a more relevant response for the particular user. The answer provided by the search engine 102 is routed back to the author in any manner described above.

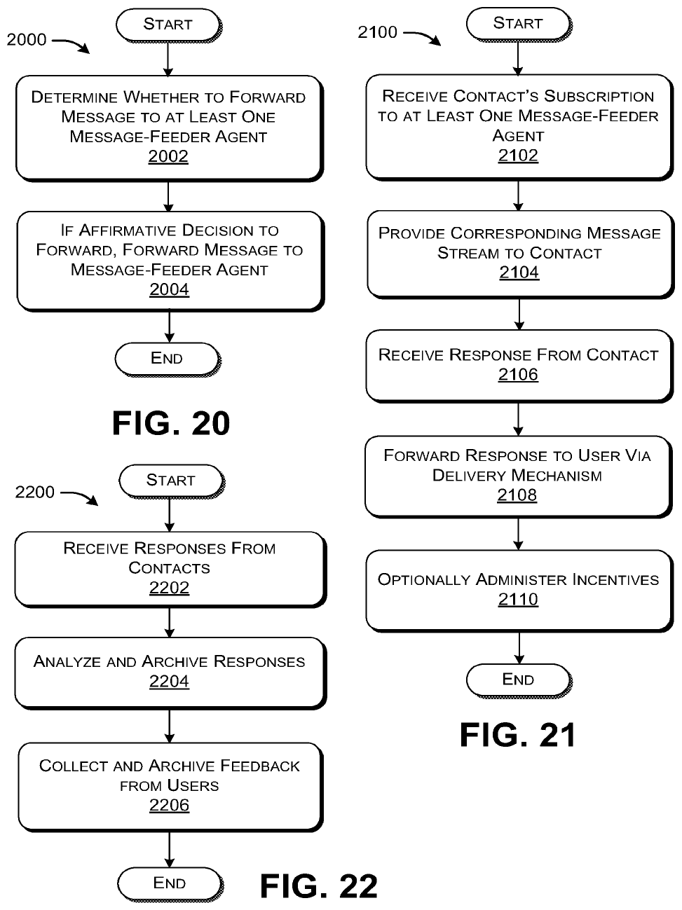

FIG. 20 shows a procedure 2000 for sending a message to a message-feeder agent. This procedure 2000 will be explained in the context of the functionality shown in FIG. 6.

In block 2002, the functionality 604 determines whether to forward a message to at least one message-feeder module.

In block 2004, if an affirmative decision is made in block 2002, the functionality 604 forwards the message to the identified message-feeder agent(s). The message can correspond to a raw search query or to a composed message that is based on the search query.

FIG. 21 shows a procedure 2100 for collecting responses to messages, where these messages are forwarded to contacts via one or more message-feeder agents. This procedure 2100 will be explained in the context of the functionality shown in FIG. 7.

In block 2102, the subscription module 704 receives a contact's subscription to at least one message-feeder agent. The contact can interact with the subscription module 704 via a social network resource.

In block 2104, after subscription, the social network resource allows the user to contact the message-feeder agent and view the stream of messages presented thereby.

In block 2106, the social network resource receives the user's response to at least one message that is presented as per block 2004.

In block 2108, the response forwarding module 706 forwards the response to the user, via any type of delivery mechanism.

In block 2110, the incentive module 708 optionally rewards the contact for responding to a message.

FIG. 22 shows a procedure 2200 for receiving and processing responses from contacts. The functionality shown in FIG. 6 can be used to implement this procedure 2200, but the procedure 2200 can also be performed in systems which omit the message-feeder agents.

In block 2202, the response receiving module 608 receives responses from the contacts.

In block 2204, the response analysis module 610 analyzes the responses. The analysis archival module 612 stores the results of the analysis in the analysis store 614.

In block 2206, the feedback collection module 616 collects the users' evaluations of the responses. The analysis archival module 612 stores the users' evaluations.

FIG. 23 shows a procedure 2300 for learning a model based on search operations conducted by the system 100, and using that model to improve the performance of the search engine 102 (and/or other aspects of the system 100). The learning functionality 124 of FIG. 1 can be used to implement this procedure 2300.

In block 2302, the learning functionality 124 identifies and stores search information regarding a subset of prior search operations for which a social network resource performed better than the search engine 102. The learning functionality 124 can make this determination based on one or more factors. For instance, a user may be presumed to be more satisfied with a social network resource compared to the search engine 102 if he or she appears to interact with the social network resource in lieu of the search engine 102. This conclusion is strengthened in those cases in which the user does not click on search results, or otherwise appears to conduct a search without a telltale terminus. In addition, or alternatively, a user may be presumed to be unsatisfied with the search engine 102 if he or she expressly enters rating information (or the like) which indicates that this is the case, and so on. For frame of reference, the learning functionality 124 can optionally also store information regarding search operations in which the search engine 102 is deemed to have satisfied the users' informational needs.

In block 2304, the leaning functionality 124 can identify and store attribute information associated with the search operations in block 2302. The attribute information can capture any characteristic(s) of the search operations. For example, the learning functionality 124 can attempt to capture attribute information which identifies common search objectives and informational needs associated with failed search attempts.

In block 2306, the learning functionality 124 can build a model based on the search information (collected in block 2302) and the attribute information (collected in block 2304). For example, the learning functionality 124 can use statistical learning methods to provide a model. That model can help better predict future occasions in which the search engine 102 typically performs poorly. More constructively, the model can help identify which search results are likely to satisfy informational needs in these circumstances.

In block 2308, the learning functionality 124 can apply the model to improve the operation of at least one aspect of the search engine 102 (and/or any other aspect of the system 100 as a whole). For example, the model can assist the search engine 102 in retrieving more effective search results, in ranking the search results in a more effective manner, and so forth. For example, the model can guide the search engine in removing or de-emphasizing those search results that the users are likely to deem unhelpful, as assessed based on their prior behavior in using the system 100. Alternatively, or in addition, the model can assist the search engine 102 in retrieving search results which are more targeted to the kind of information gleaned by the users from their social contacts, and so on.

C. Representative Processing Functionality

FIG. 24 sets forth illustrative computing functionality 2400 that can be used to implement any aspect of the functions described above. With reference to FIG. 1, for instance, the type of computing functionality 2400 shown in FIG. 24 can be used to implement any aspect of the search engine 102, any aspect of the social network resources 104, any aspect of the integration module 116, any aspect of the result storage module 118, any aspect of the client modules (108, 110, . . . 112), etc. In one case, the computing functionality 2400 may correspond to any type of computing device that includes one or more processing devices.

The computing functionality 2400 can include volatile and non-volatile memory, such as RAM 2402 and ROM 2404, as well as one or more processing devices 2406. The computing functionality 2400 also optionally includes various media devices 2408, such as a hard disk module, an optical disk module, and so forth. The computing functionality 2400 can perform various operations identified above when the processing device(s) 2406 executes instructions that are maintained by memory (e.g., RAM 2402, ROM 2404, or elsewhere). More generally, instructions and other information can be stored on any computer readable medium 2410, including, but not limited to, static memory storage devices, magnetic storage devices, optical storage devices, and so on. The term computer readable medium also encompasses plural storage devices.

The computing functionality 2400 also includes an input/output module 2412 for receiving various inputs from a user (via input modules 2414), and for providing various outputs to the user (via output modules). One particular output mechanism may include a presentation module 2416 and an associated graphical user interface (GUI) 2418. The computing functionality 2400 can also include one or more network interfaces 2420 for exchanging data with other devices via one or more communication conduits 2422. One or more communication buses 2424 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method performed by one or more computing devices, the method comprising:
receiving search strings inputted by users of a search engine and received from client devices operated by the users, the search engine comprising an index of documents on the Internet and transmitting to the client devices search results pages comprising respective listings of links to documents determined by the search engine, according to the index, to be relevant to the respective search strings submitted to the search engine;
receiving by the search engine, from a user device operated by a user, a search string entered by the user during a search session with the search engine, and based on receiving the search string, the search engine, or a module in communication therewith:
analyzing the search string to identify a topic of the search string;
automatically determining that the identified topic is among a set of pre-defined topics, and based on the determining: (i) automatically formulating a message comprising content automatically generated based on the search string, and (ii) automatically forwarding the message to a social network without input or approval from the user; and
receiving, from the social network, replies to the message forwarded to the social message, the replies sent by users of the social network in response to user devices operated thereby receiving the message;
generating, by the search engine, a search result page corresponding to the search string;
sending the search result page from the search engine to the user device for display thereby; and
sending the replies, by the search engine or the module, to the user device for display thereby.

2. A method according to claim 1, further comprising:
setting a time for how long the message is to be presented for review by the social network users who receive the message.

3. A method according to claim 2, further comprising:
determining that a user of the social network has not viewed or responded to the message before the time and removing the message from consideration by the user of the social network; and
routing the message to another user of the social network based on removing the message from consideration.

4. A method according to claim 1, wherein the search engine or the module determines to automatically forward the message to the social network based on a user action directed to the search engine during the search session and before submitting the search string to the search engine.

5. A method according to 1 claim 1, wherein the message is sent to the user devices of the users of the social network without identifying the user to the users of the social network.

6. A method according to claim 5, wherein the replies provided to the user device do not identify whichever users of the social network provided the replies.

7. A method according to claim 1, further comprising:
receiving by the search engine, from the user device, a second search string entered by the user during the search session, and based on receiving the second search string:
generating, by the search engine, a second search result page corresponding to the second search string;
including, by the search engine or the module, in the second search result page:
(i) one or more of the replies or (ii) a user interface element configured to respond to user activation thereof by displaying one or more of the replies; and
sending the second search result page from the search engine to the user device for display thereby.

8. A method performed by one or more computing devices, the method comprising:
receiving, by an Internet search engine, from a user device operated by a user of an Internet search engine, a search string inputted by the user at the user device, the search engine comprising an index indexing documents on the Internet;
analyzing, by the Internet search engine or a module in communication therewith, the search string, to identify a feature of the search string, and based on the identified feature, determining, by the Internet search engine or the module, to automatically generate and automatically send a message comprising content about the search string to a social network in communication with the Internet search engine, wherein the social network posts messages to users thereof and receives replies to the posted messages, and wherein, based on the determining, without receiving an approval input from the user, the Internet search engine or the module sends the message to the social network;
generating, by the Internet searching engine applying the search string to the index, a search results page corresponding to the search string, wherein the search results page comprises links to documents in the search index that the search engine determined, according to the search index, to be relevant to the search string;
receiving, by the Internet search engine or the module, from the social network, replies to the message, the replies provided by devices operated by users of the social network that received the message and generated the replies based on the message, the replies received by being posted to the social network;
sending, by the Internet search engine, the search results page to the user device in response to receiving the search string from the Internet search engine; and
sending the received replies to the user device.

9. A method according to claim 8, wherein the feature of the search string comprises the search string being in the form of a question.

10. A method according to claim 9, further comprising determining that the search string comprises a topic that matches a topic pre-determined to be associated with the social network, wherein the determining is further based on the topic of the search string being determined to match the pre-determined topic associated with the social network.

11. A method according to claim 8, wherein the search results page does not comprise any of the received replies or any links thereto.

12. A method according to claim 8, wherein a plurality of modules in communication with the Internet search engine are respectively associated with social networks, wherein the module forwards the message to the social network, and wherein the determining includes selecting the module, from among the plurality of modules, based on the feature of the search string.

13. A method according to claim 8, further comprising capturing supplemental information about the user and including the supplemental information with the message sent to the social network.

14. A method according to claim 13, wherein the supplemental information comprises a location of the user device or information about a search session the Internet search string and other search strings submitted to the Internet search engine via the user device.

15. A method according to claim 8, further comprising, by the Internet search engine or the module: generating a response page comprising the replies or links thereto and sending the response page to the user device for display thereby, wherein the response page does not comprise an index-based search results page of the search engine.

16. A method according to claim 15, wherein only replies received within a predefined period of time are included in the response page.

17. A method performed by one or more computing devices, the method comprising:
receiving a search string inputted by a user of a search engine and sent from a client device operated by the user, the search string comprising one or more search terms, the search engine comprising an index of documents on the Internet;
transmitting, by the search engine, to the client device, a search result page corresponding to the search string, the search result page comprising links to documents determined by the search engine, according to the index, to be relevant to the search terms;
analyzing the search terms to identify a topic of the search string, and based on the topic of the search string, without intervention from the user, automatically sending a message about the search string to a social network;
receiving from the social network, by the search engine, replies to the message submitted by users of the social network in response to the message; and
transmitting the replies to the client device for display thereby.

18. A method according to claim 17, wherein the replies are not included with the search result page.

19. A method according to claim 17, further comprising automatically generating content of the message based on the search terms.

20. A method according to claim 17, wherein the social network is selected from among candidate social networks based on a pre-determined association between the topic of the search string and the social network.
